(19) United States
(12) Patent Application Publication
(10) Pub. No.: US 2026/0304394 A1
(43) Pub. Date: Oct. 1, 2026

(54) TIME DOMAIN RESOURCE ALLOCATION (TDRA) FOR MULTI-CELL MULTI-TRANSMISSION SCHEDULING

(71) Applicant: QUALCOMM Incorporated, San Diego, CA (US)

(72) Inventors: Javier RODRIGUEZ FERNANDEZ, San Diego, CA (US); Kazuki TAKEDA, Tokyo (JP)

(21) Appl. No.: 19/555,876

(22) Filed: Mar. 3, 2026

Related U.S. Application Data
(60) Provisional application No. 63/779,860, filed on Mar. 28, 2025.

(51) Int. Cl. H04W 72/0446; H04L 5/00

(52) U.S. Cl. CPC H04W 72/0446; H04L 5/0044

(57) ABSTRACT

Certain aspects of the present disclosure provide techniques for time domain resource allocation (TDRA). A method of wireless communications by a user equipment (UE). The method includes receiving signaling configuring a set of TDRAs for multiple cells. At least one TDRA of the set of TDRAs is configured with multiple transmission allocations for one cell. The method includes receiving signaling indicating at least one TDRA of the set of TDRAs. The method includes communicating based on the indicated TDRA.

### CROSS-REFERENCE TO RELATED APPLICATIONS

This application claims priority to U.S. Provisional Application No. 63/779,860, filed Mar. 28, 2025, which is hereby incorporated by reference in its entirety.

### FIELD OF THE DISCLOSURE

Aspects of the present disclosure relate to wireless communications, and more particularly, to techniques for time domain resource allocation (TDRA).

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

A communication system may include a wireless communication network (such as a radio access network (RAN)) that supports communication between wireless communication devices such as network entities (such as base stations (BSs)), client devices (such as one or more user equipments (UEs)), and others. Such devices may communicate with one another using a variety of protocols (e.g., radio access technologies (RATs) that have been adopted in various telecommunication standards, which define common protocols that enable different wireless communication devices to communicate on a local, municipal, national, regional, or global level, including those of cellular-based systems such as fourth generation (4G) systems (e.g., Long Term Evolution (LTE) systems), fifth generation (5G) systems (such as 5G New Radio (5G-NR) systems), and sixth generation (6G) systems that are part of a continuous mobile broadband evolution promulgated by the Third Generation Partnership Project (3GPP). A wireless communication network may support communication by implementing system resources (such as frequency resources, time resources, spatial resources) in accordance with a wireless communication protocol.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications by a user equipment (UE). The method includes receiving signaling configuring a set of time domain resource allocations (TDRAs) for multiple cells. At least one TDRA of the set of TDRAs is configured with multiple transmission allocations for one cell. The method includes receiving signaling indicating at least one TDRA of the set of TDRAs. The method includes communicating based on the indicated TDRA.

Another aspect provides a method of wireless communications by a network entity. The method includes transmitting signaling configuring a set of TDRAs for multiple cells. At least one TDRA of the set of TDRAs is configured with multiple transmission allocations for one cell. The method includes transmitting signaling indicating at least one TDRA of the set of TDRAs. The method includes communicating based on the indicated TDRA.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow for the time domain resource allocation (TDRA).

FIG. 6 depicts a method for wireless communications by a user equipment.

FIG. 7 depicts a method for wireless communications by a network entity.

FIG. 8 depicts aspects of an example user equipment.

FIG. 9 depicts aspects of an example network entity.

### DETAILED DESCRIPTION

Aspects of the present disclosure provide apparatuses, methods, processing systems, and computer-readable mediums for time domain resource allocation (TDRA). Some aspects provide TDRA configuration and signaling for multiple cell (multi-cell) multiple-transmission (multi-transmission), in which TDRAs are configured for multiple cells and where multiple transmissions can be scheduled within one cell.

In some systems, TDRA tables are configured for multi-transmission scheduled, but cannot be used for scheduling multiple cells. In other systems, TDRA tables are configured for multi-cell scheduling, but cannot be used for scheduling multiple transmissions within a cell. Thus, such TDRA table configurations do not support multi-cell multi-transmission scheduling, which limits the ability to efficiently schedule multiple physical downlink shared channel (PDSCH) or physical uplink shared channel (PUSCH) transmissions across multiple cells. Additionally, when multiple cells and multiple transmissions are scheduled, the radio resource control (RRC) signaling overhead may scale considerably depending on the amount of flexibility configured, creating a need for techniques to reduce the configuration payload.

According to certain aspects of the present disclosure, multi-transmission TDRA tables may be configured for multiple cells. In some aspects, the multi-transmission TDRA tables may be configured per bandwidth part (BWP) of each cell of multiple cells.

According to certain aspects of the present disclosure, multi-transmission TDRA tables may be configured for multiple cells, enabling joint multi-cell multi-transmission scheduled.

In some aspects, new signaling and parameters may be defined for the multi-cell multi-transmission TDRA configuration and signaling. In some aspects, a user equipment (UE) receives signaling configuring a set of TDRAs for multiple cells, where at least one TDRA of the set of TDRAs is configured with multiple transmission allocations for one cell. The UE receives signaling indicating at least one TDRA of the set of TDRAs and communicates based on the indicated TDRA. The signaling may configure a list of multi-transmission TDRA allocations, where each allocation includes TDRA indexes for each bandwidth part (BWP) of each cell.

Multi-cell multi-transmission scheduling allows multiple cells to be scheduled, and multiple transmissions to be scheduled in the cells, including the scheduling of multiple transmissions within a cell, providing improved spectral efficiency and resource utilization, enhanced reliability and diversity gains, low latency, improved load balancing, and efficient use of dual connectivity and carrier aggregation. The configuration of joint TDRA tables for the multi-cell multi-transmission allows downlink control information (DCI), such as to DCI format 1_3 for multi-cell multi-PDSCH scheduling or DCI format 0_3 for multi-cell multi-PUSCH scheduling, to efficiently indicate TDRA index which can map to the TDRA for multiple cells and multiple transmissions, including multiple transmissions within a cell. Enhanced reliability and diversity gains are achieved through the ability to schedule transmissions across multiple cells. Additionally, the joint scheduling approach may support low latency communications, improved load balancing, and efficient use of dual connectivity and carrier aggregation.

In some aspects, techniques are provided for reducing the overhead of the TDRA configuration and signaling. In some aspects, the same TDRA are configured for BWPs of a cell having a same subcarrier spacing (SCS). Accordingly, the signaling overhead will not scale based on the number of BWPs except for those having different SCSs.

### Introduction to Wireless Communications Networks

The techniques and methods described herein may be used for various wireless communications networks. While aspects may be described herein using terminology commonly associated with 4G, 5G, and/or 6G wireless technologies, aspects of the present disclosure may likewise be applicable to other communications systems and standards not explicitly mentioned herein.

A communication system may include a RAN that supports wireless communication. Communication in a RAN may be performed in accordance with one or more RATs, including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread OFDM (DFT-S-OFDM), among others.

A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others. To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

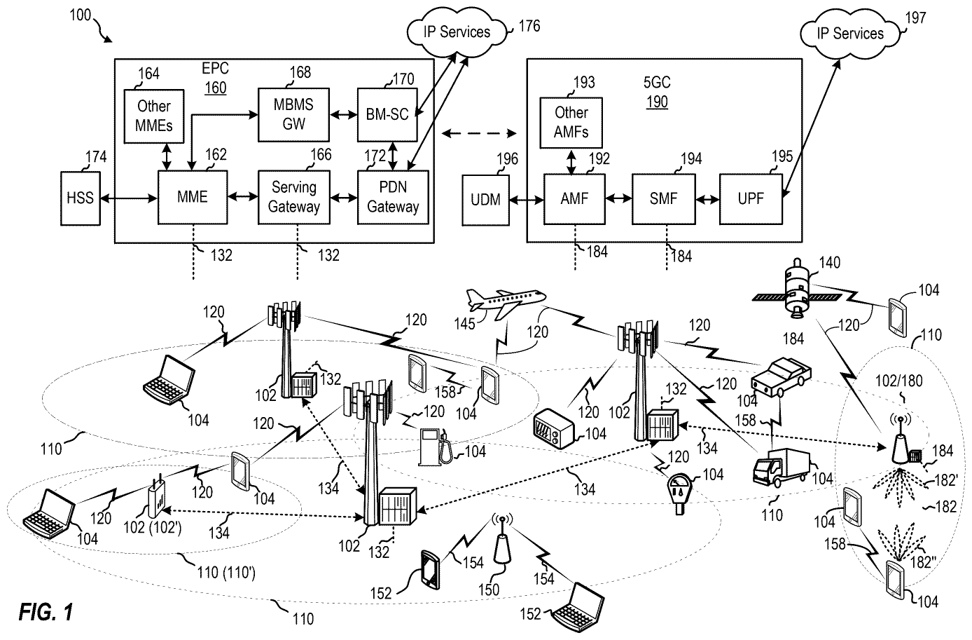

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a UE, a BS, a component of a BS, a server, etc.). For example, various functions of a network as well as various devices associated with and interacting with a network may be considered network entities. Further, wireless communications network 100 includes terrestrial aspects, such as ground-based network entities 102, and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes network entities 102, UEs 104, and one or more core networks, such as an evolved packet core (EPC) 160 and core network 190 (e.g., such as a 5G Core (5GC) network or 6G core (6GC) network, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

A network entity 102 may support wireless communication in accordance with one or more coverage areas 110, and may be referred to as a network element, a network node, a RAN node, or network equipment, among other nomenclature.

Network entities 102 wirelessly communicate with (e.g., transmit signals to or receive signals from) UEs 104 via communications links 120. The communications links 120 between network entities 102 and UEs 104 may include uplink (UL) (also referred to as reverse link) transmissions from a UE 104 to a network entity 102 and/or downlink (DL) (also referred to as forward link) transmissions from a network entity 102 to a UE 104. The communications links 120 may use multiple-input and multiple-output (MIMO) antenna technology, including spatial multiplexing, beamforming, and/or transmit diversity in various aspects. MIMO communication generally refers to transmitting or receiving multiple signals (such as multiple layers or multiple data streams) simultaneously over the same time and frequency resources. To implement beamforming, the amplitudes or phases of signals transmitted via antenna elements may be modulated and shifted relative to each other (such as by manipulating a phase shift, a phase offset, or an amplitude) to generate one or more beams. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, the wireless communication network 100 may implement multi-TRP (mTRP) operation (including redundant transmission or reception on multiple TRPs) or non-coherent joint transmission (NC-JT).

The network entity 102 and the UE 104 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network entity 102 transmitting signals (for example, SSBs or other signals) via respective beams and the UE 104 receiving and measuring the signal(s) via respective beams of multiple beams to identify a best beam (or beam pair) for communication between the UE 104 and the network entity 102. A beam refinement operation may involve a first device (for example, the UE 104 or the network entity 102) transmitting signal(s) via a subset of beams (for example, identified based on, or otherwise associated with, measurements reported as part of one or more other beam management operations). A second device (for example, the network entity 102 or the UE 104) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

One or more of the network entities 102 may include or may be referred to as a BS. Depending on its capabilities, a BS may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, an access point, a base transceiver station, radio BS, radio transceiver, transceiver function, a transmission reception point, or other suitable terminology.

Each of network entities 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells. The wireless communication network 100 may include a heterogeneous network in which different types of network entities 105 support communication for one or more coverage areas 110 using the same or different RATs.

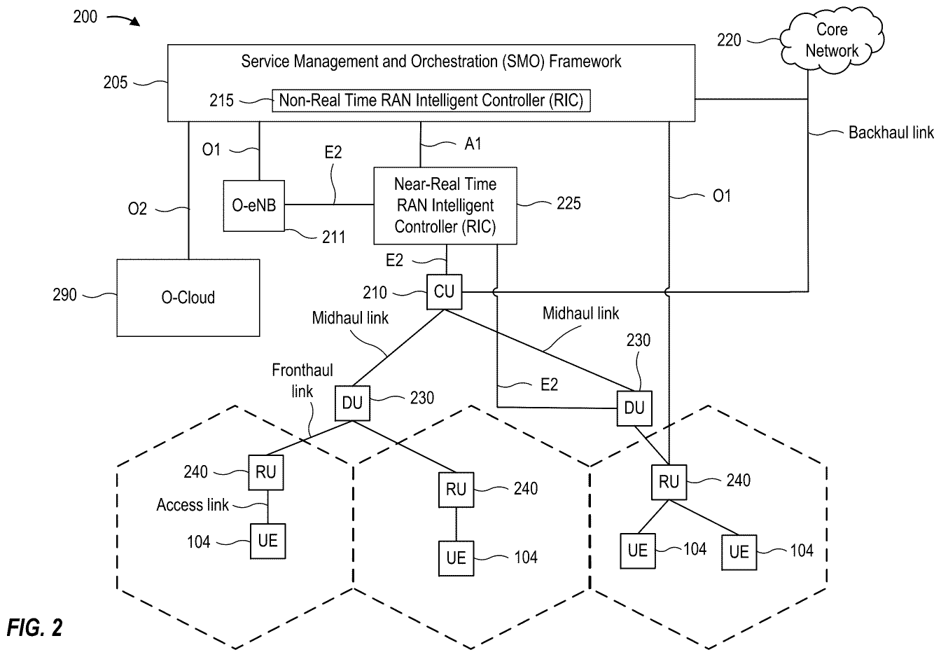

In some examples, a network entity 102 may be implemented in an aggregated (such as monolithic, standalone) architecture, which may utilize a protocol stack that is physically or logically integrated within one network entity 105 (such as a single physical RAN node). While network entities 102 are depicted in various aspects as unitary communications devices, network entities 102 may be implemented in various configurations. More generally, a BS (e.g., network entity 102) may include components that are located at a single physical location or components located at various physical locations. In examples in which a BS includes components that are located at various physical locations, the various components may each perform functions such that, collectively, the various components achieve functionality that is similar to a BS that is located at a single physical location. For example, one or more components of a BS may be disaggregated, which may utilize a protocol stack that is physically or logically distributed among multiple network entities 105, including in an integrated access and backhaul (IAB) network, an open RAN (O-RAN), or a virtualized RAN (vRAN). A disaggregated BS may include a central unit (CU), one or more distributed units (DUs), one or more radio units (RUs), a Near-Real Time (Near-RT) RAN Intelligent Controller (RIC), or a Non-Real Time (Non-RT) RIC, to name a few examples. FIG. 2 depicts and describes an example disaggregated BS architecture. In another example, various aspects of a BS may be virtualized. The wireless communication system may implement a service-based architecture that provides a modular framework in which control plane functionality and common data repositories may be delivered through a set of interconnected network functions (NFs) that may access services of other NFs.

Different network entities 102 within wireless communications network 100 may also be configured to support different RATs, such as 4G, 5G, and/or 6G. For example, network entities 102 configured for 4G LTE (collectively referred to as Evolved Universal Mobile Telecommunications System (UMTS) Terrestrial RAN (E-UTRAN)) may interface with the EPC 160 through first backhaul links 132 (e.g., an S1 interface). Network entities 102 may interface with core network 190 through second backhaul links 184. Network entities 102 may communicate directly or indirectly (e.g., through the EPC 160 or core network 190) with each other over third backhaul links 134 (e.g., X2 interface), which may be wired or wireless.

Wireless communications network 100 may subdivide the electromagnetic spectrum into various classes, licensed or unlicensed operating bands, frequency ranges, component carriers, or channels, which define associated frequencies available for communications. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7.125 GHz, which is often referred to (interchangeably) as “Sub-6 GHz”; FR3 as including frequency resources between 7.125 GHz and 24.25 GHz; and F2 as including 24.25 GHz-71.00 GHz, which is sometimes referred to (interchangeably) as a “millimeter wave” (“mmW” or “mmWave”). In some cases, FR2 may be further defined in terms of sub-ranges, such as a first sub-range FR2-1 including 24.25 GHz-52.60 GHz and a second sub-range FR2-2 including 52.60 GHz-71.00 GHz (also referred to as FR4). Communications above the upper frequency band (such as between mmW and THz frequencies, between 100 GHz and 1 THz) may be referred to as sub-Terahertz (sub-THz) communication, for example, including FR5 (114.25 GHz through 300 GHz).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 104 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network entity 102 transmitting downlink control information (DCI) to the one or more UEs 104) or reconfigured (for example, in real-time or near-real-time) according to changing network conditions in the wireless communications network 100 or specific requirements of one or more UEs 104. An active BWP defines the operating bandwidth of the UE 104 within the operating bandwidth of the serving cell.

A BS configured to communicate using mmWave/near mmWave radio frequency bands (e.g., a mmWave BS such as BS 180) may utilize beamforming (e.g., 182) with a UE (e.g., 104) to improve path loss and range.

The communications links 120 between network entities 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BS s (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a mobility management entity (MME) 162, other MMEs 164, a serving gateway 166, a multimedia broadcast multicast service (MBMS) gateway 168, a broadcast multicast service center (BM-SC) 170, and/or a packet data network (PDN) gateway 172, such as in the depicted example. MME 162 may be in communication with a home subscriber server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN gateway 172. PDN gateway 172 provides UE IP address allocation as well as other functions. PDN gateway 172 and the BM-SC 170 are connected to IP Services 176, which may include, for example, the Internet, an intranet, an IP multimedia subsystem (IMS), a packet switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS bearer services within a public land mobile network (PLMN), and/or may be used to schedule MBMS transmissions. MBMS gateway 168 may be used to distribute MBMS traffic to the network entities 102 belonging to a multicast broadcast single frequency network (MBSFN) area broadcasting a particular service, and/or may be responsible for session management (start/stop) and for collecting eMBMS related charging information.

Core network 190 may include various functional components, including: an access and mobility management function (AMF) 192, other AMFs 193, a session management function (SMF) 194, and a user plane function (UPF) 195. AMF 192 may be in communication with unified data management (UDM) 196.

AMF 192 is a control node that processes signaling between UEs 104 and core network 190. AMF 192 provides, for example, quality of service (QoS) flow and session management.

IP packets are transferred through UPF 195, which is connected to the IP services 197, and which provides UE IP address allocation as well as other functions for core network 190. IP Services 197 may include, for example, the Internet, an intranet, an IMS, a PS streaming service, and/or other IP services.

In various aspects, a network entity or network node can be implemented as an aggregated BS, as a disaggregated BS, a component of a BS, an integrated access and backhaul (IAB) node, a relay node, a sidelink node, to name a few examples. Wireless backhaul, midhaul, or fronthaul may be implemented via one or more IAB nodes, which may act as a relay using resources of an IAB donor network entity 102. The wireless communication network 100 may include one or more of a relay that may steer or reflect signals transmitted by other entities, which may support any of the described communication links. A relay may include active elements or passive elements, and may be in the form of a reconfigurable intelligent surface (RIS). A RIS may include tunable reflecting antenna arrays or metasurfaces, which may be used to enhance coverage or efficiency in multipath environments.

Some aspects and techniques as described herein may be implemented, at least in part, using an AI/ML model, such as a program that includes a machine learning (ML) model or an artificial neural network (ANN) model. The AI/ML model may be deployed at one or more devices (for example, one or more network entities 102, one or more UEs 104, one or more servers, or one or more components of a cloud computing network, among other examples). For example, in a deployment in which AI/ML functionality is performed independently at a device, sometimes referred to as “overlay AI/ML,” Additionally, or alternatively, in a deployment where AI/ML functionality is coordinated between different devices, sometimes referred to as “coordinated AI/ML,” or performed at all device and network layers, sometimes referred to as “native AI/ML,” the AI/ML model (or an instance of the AI/ML model) may be deployed at multiple devices (for example, a first portion of the AI/ML model may be deployed at a UE 104 and a second portion of the AI/ML model may be deployed at a network entity 102). In other examples of coordinated AI/ML or native AI/ML, a first AI/ML model may be deployed at a UE 104 and a second AI/ML model may be deployed at a network entity 102. The AI/ML model(s) may be configured to enhance various aspects of the wireless communications network 100 (for example, to increase privacy, reliability, or efficient use of network bandwidth, or to reduce latency, among other examples). For example, the AI/ML model(s) may be trained to identify patterns or relationships in data corresponding to the wireless communications network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 104, device selection criteria (for example, according to a geographical area where measurements are to be collected or UE capabilities to be used to collected measurements), or reporting configurations (for example, reporting parameters such as location, time, or sensori information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

FIG. 2 depicts an example disaggregated network entity 200 architecture. The disaggregated network entity 200 architecture may include one or more CUs 210 that can communicate directly with a core network 220 via a backhaul link, or indirectly with the core network 220 through one or more disaggregated BS units (such as a near-real time (Near-RT) RAN intelligent controller (RIC) 225 via an E2 link, or a non-real time (Non-RT) RIC 215 associated with a service management and orchestration (SMO) framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., CU-User Plane (CU-UP)), control plane functionality (e.g., CU-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO framework 205 may be configured to support the deployment of dedicated physical resources for RAN coverage requirements which may be managed via an operations and maintenance interface (such as an O1 interface). For virtualized network elements, the SMO framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and near-RT RICs 225. In some implementations, the SMO framework 205 can communicate with a hardware aspect of a 4G RAN, such as an open eNB (O-eNB) 211, via an O1 interface. Additionally, in some implementations, the SMO framework 205 can communicate directly with one or more RUs 240 via an O1 interface. The SMO framework 205 also may include a non-RT RIC 215 configured to support functionality of the SMO framework 205.

The non-RT RIC 215 may be configured to include a logical function that enables non-real-time control and optimization of RAN elements and resources, AI/ML workflows including model training and updates, or policy-based guidance of applications/features in the near-RT RIC 225. The non-RT RIC 215 may be coupled to or communicate with (such as via an A1 interface) the near-RT RIC 225. The near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the near-RT RIC 225.

In some implementations, to generate AI/ML models to be deployed in the near-RT RIC 225, the non-RT RIC 215 may receive parameters or external enrichment information from external servers. Such information may be utilized by the near-RT RIC 225 and may be received at the SMO framework 205 or the non-RT RIC 215 from non-network data sources or from network functions. In some examples, the non-RT RIC 215 or the near-RT RIC 225 may be configured to tune RAN behavior or performance. For example, the non-RT RIC 215 may monitor long-term trends and patterns for performance and employ AI/ML models to perform corrective actions through the SMO Framework 205 (such as reconfiguration via 01) or via creation of RAN management policies (such as A1 policies).

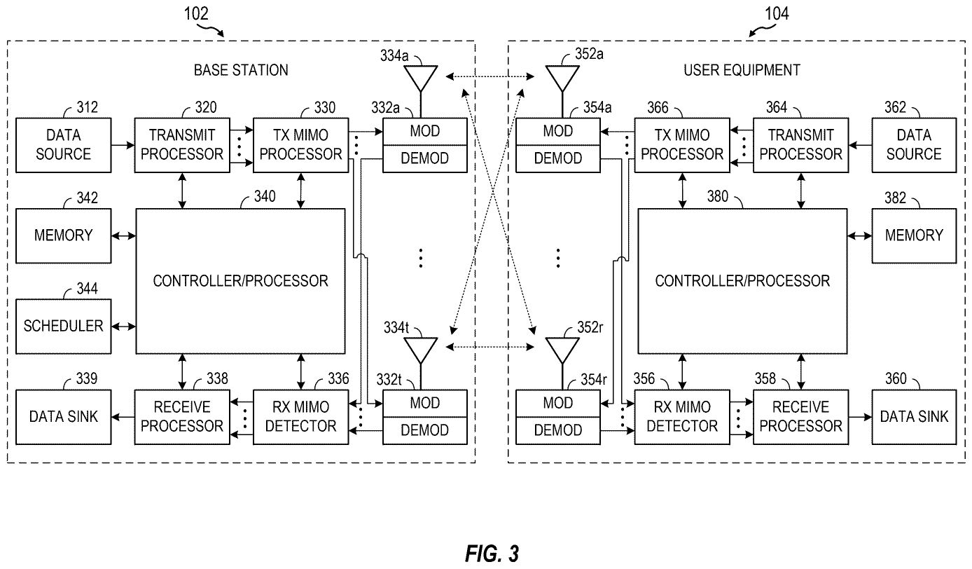

FIG. 3 depicts aspects of an example network entity 102 and a UE 104.

Generally, network entity 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, network entity 102 may send and receive data between network entity 102 and UE 104. Network entity 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, network entity 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), channel state information reference signal (CSI-RS), phase tracking reference signal (PTRS), or tracking reference signal (TRS).

Transmit (TX) MIMO processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the network entity 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to network entity 102.

In some examples, the network entity 102 or the UE 104 may perform a channel coding operation or a FEC operation to control errors in transmitted information. For example, the network entity 102 or the UE 104 may perform an encoding operation to generate encoded information (such as by selectively introducing redundancy into the information, typically using an error correction code (ECC), such as a polar code or a low-density parity-check (LDPC) code).

The network entity 102 or the UE 104 may further perform spatial processing (for example, precoding) on the encoded information to generate one or more processed or precoded signals for downlink or uplink transmission, respectively. In some examples, the network entity 102 or the UE 104 may perform codebook-based precoding or non-codebook-based precoding. Codebook-based precoding may involve selecting a precoder (for example, a precoding matrix) using a codebook. For example, the network entity 102 may provide precoding information indicating which precoder, defined by the codebook, is to be used by the UE 104. Non-codebook-based precoding may involve selecting or deriving a precoder based on, or otherwise associated with, one or more downlink or uplink signal measurements. The network entity 102 or he UE 104 may transmit the processed downlink or uplink signals, respectively, via one or more antennas.

At network entity 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for network entity 102 and UE 104, respectively.

Scheduler 344 may schedule UEs for data transmission on the downlink and/or uplink.

In various aspects, network entity 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network entity 102 to a UE 104. DCI generally contains the information the UE 104 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples.

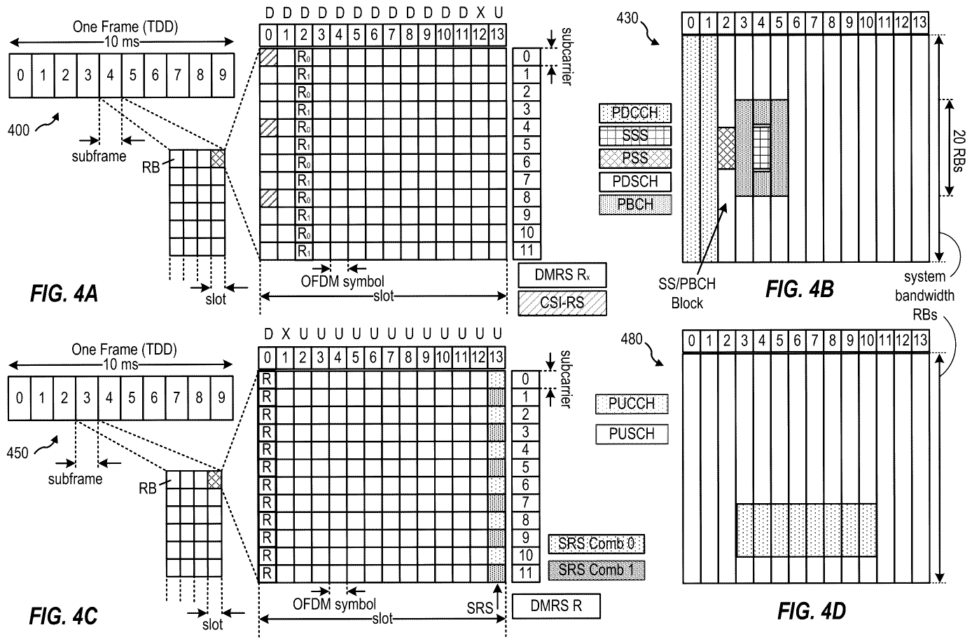

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize OFDM with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD) or in a sub-band full duplex (SBFD) configuration, in which, for a particular set of subcarriers, subframes within the set of subcarriers are dedicated for both DL and UL.

In FIGS. 4A and 4C, the wireless communications frame structure is TDD where Dis DL, U is UL, and Xis flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a RB (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include DMRS and/or CSI-RS for channel estimation at the UE. The RS may also include beam measurement RS (BRS), beam refinement RS (BRRS), and/or PT-RS.

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., 104 of FIGS. 1 and 3) to determine subframe/symbol timing and a physical layer identity.

A SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The PBCH, which carries a master information block (MIB), may be logically grouped with the PSS and SSS to form a synchronization signal (SS)/PBCH block. The MIB provides a number of RBs in the system bandwidth and a system frame number (SFN). The PDSCH carries user data, broadcast system information not transmitted through the PBCH such as system information blocks (SIBs), and/or paging messages. For example, a PDSCH can carry a MAC control element (MAC-CE), an RRC message, or user data, among other examples. Each PDSCH may carry one or more transport blocks (TBs) of data.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit SRS. The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, CSI, and HARQ ACK/NACK feedback. CSI can include a channel quality indicator (CQI) (indicative of downlink channel conditions to facilitate selection of transmission parameters, such as an MCS, by a network entity 102), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. The PUSCH carries data, and may additionally be used to carry a buffer status report (BSR), a power headroom report (PHR), and/or UCI. Each PUSCH may carry one or more TBs of data.

The information (for example, data, control information, or reference signal information) transmitted by a network entity 102 to a UE 104, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network entity 102 or a UE 104 over a wireless communication channel. In some examples, the network entity 102 or the UE 104 may select an MCS (for example, an order of quadrature amplitude modulation (QAM), such as 64-QAM, 128-QAM, or 256-QAM, among other examples) for a downlink signal or an uplink signal. For example, the network entity 102 may select an MCS for a downlink signal in accordance with UCI received from the UE 104 or may transmit, to the UE 104, an indication of an MCS to be applied for an uplink signal.

### Aspects Related to Multi-Cell Scheduling Configuration

In certain systems, multiple cell (multi-cell) scheduling is supported. In some examples, scheduling of one physical downlink shared channel (PDSCH) or one physical uplink shared channel (PUSCH) per cell, of the multiple cells, is supported.

In some aspects, a user equipment (UE) is configured with multiple cells or sets of cells. In some aspects, the UE is configured via higher layer signaling with the multiple cells or sets of cells. In some examples, the UE is configured via a radio resource configuration (RRC) information element with the multiple cells or sets of cells.

In some aspects, the multi-cell PDSCH or multi-cell PUSCH may be scheduled by a downlink control information (DCI). For example, the multi-cell PDSCH may be scheduled by a DCI format 1_3 and the multi-cell PUSCH may be scheduled by a DCI format 0_3.

In some aspects, the UE is configured to monitor the DCI formats in a cell for multi-cell scheduling for a set of cells across sets of the cells the UE has been configured with.

One example of an RRC IE configuring multiple cells is specified in Section 6.3.2 of 3GPP TS 38.331 v18.5.1. In one example, the UE is configured via a serving cell configuration (e.g., ServingCellConfig IE) with the multiple cells or sets of cells. For example, the serving cell configuration may include one or more parameters (e.g., mc-DCI-SetofCellsToAddModList, MC-DCI-SetofCells) configuring the multiple cells or sets of cells.

The parameters may indicate identifiers of cell sets (e.g., setOfCellsID) to be indicated in a DCI, a value for identifying cells (e.g., nCI-Value). The value for identifying cells may be used by the UE in a physical downlink control channel (PDCCH) hashing function to retrieve DCI candidates for monitoring.

The parameters may include a parameter (e.g., ScheduledCellCombo) indicating combinations of co-scheduled cells.

The parameters may include a parameter configuring the joint TDRA table for uplink scheduling (e.g., tdra-FieldIndexListDCI-0-3). The parameter configuring the joint TDRA table for uplink scheduling may map DCI TDRA fields to TDRA indexes. In some aspects, the parameter configuring the joint TDRA table for uplink scheduling maps up to 64 TDRA indexes.

The parameters may include a parameter configuring the joint TDRA table for downlink scheduling (e.g., tdra-FieldIndexListDCI-1-3). The parameter configuring the joint TDRA table for downlink scheduling may map DCI TDRA fields to TDRA indexes. In some aspects, the parameter configuring the joint TDRA table for downlink scheduling may include a list of up to 32 TDRA indexes

The parameters may provide TDRA indices of a TDRA table. For example, the TDRA-FieldIndexDCI-0-3 configures each row of a joint TDRA field table for uplink scheduling via DCI format 0_3, and contains applicable TDRA field indexes for multiple BWPs/cells. The mapping for the uplink TDRA table may include a list of TDRA field indexes up to a maximum number. For example, the TDRA-FieldIndexDCI-0-3 may configure from 2 up to maxNrofBWPsInSetOfCells for up to a maximum number uplink allocations (e.g., maxNrofUL-Allocations). The TDRA index for a BWP of a cell points to a corresponding TDRA in the TDRA table and the order of TDRA index in each row refers the BWP identifier (e.g., BWP-Id) for a cell and the order of cells (e.g., in scheduledCellListDCI-0-3). The number of TDRA indices in a row of TDRA-FieldIndexDCI-0-3 may be the same as the total number of BWPs that can be scheduled by the DCI format 0_3 across cells included in scheduledCellListDCI-0-3.

The parameter TDRA-FieldIndexDCI-1-3) may provide TDRA indices of the joint TDRA field table for downlink scheduling via DCI format 1_3. The mapping for the downlink TDRA table may include a list of TDRA field indexes up to a maximum number. For example, the TDRA-FieldIndexDCI-1-3 may configure from 2 up to maxNrofBWPsInSetOfCells for up to a maximum number downlink allocations (e.g., maxNrofDL-Allocations).

One example below is an example portion of a serving cell configuration:

```
-- ASN1START
-- TAG-SERVINGCELLCONFIG-START
ServingCellConfig ::= SEQUENCE {
...
MC-DCI-SetOfCells-r18 ::= SEQUENCE {
          setOfCellsId-r18 SetOfCellsId-r18,
          nCI-Value-r18 INTEGER (0..7),
          scheduledCellListDCI-1-3-r18 SEQUENCE (SIZE (2..maxNrofCellsInSet-
r18)) OF ServCellIndex OPTIONAL, -- Need R
          scheduledCellListDCI-0-3-r18 SEQUENCE (SIZE (2..maxNrofCellsInSet-
r18)) OF ServCellIndex OPTIONAL, -- Need R
          scheduledCellComboListDCI-1-3-r18 SEQUENCE (SIZE (1..maxNrof
CellCombos-r18)) OF ScheduledCellCombo-r18 OPTIONAL, -- Need R
          scheduledCellComboListDCI-0-3-r18 SEQUENCE (SIZE (1..maxNrof
CellCombos-r18)) OF ScheduledCellCombo-r18 OPTIONAL, -- Need R
...
          tdra-FieldIndexListDCI-1-3-r18 SEQUENCE (SIZE (1..32)) OF TDRA-
FieldIndexDCI-1-3-r18 OPTIONAL, -- Need R
          tdra-FieldIndexListDCI-0-3-r18 SEQUENCE (SIZE (1..64)) OF TDRA-
FieldIndexDCI-0-3-r18 OPTIONAL, -- Need R
...
SetOfCellsId-r18 ::= INTEGER (0..maxNrofSetsOfCells-1-r18)
ScheduledCellCombo-r18 ::= SEQUENCE (SIZE (1..maxNrofCellsInSet-r18))
OF INTEGER (0..maxNrofCellsInSet-1-r18)
...
TDRA-FieldIndexDCI-1-3-r18 ::= SEQUENCE (SIZE (2...maxNrofBWPsInSetOf
Cells-r18)) OF INTEGER (0...maxNrofDL-Allocations-1-r18)
TDRA-FieldIndexDCI-0-3-r18 ::=  SEQUENCE  (SIZE (2...maxNrofBWPsInSetOf
Cells-r18)) OF INTEGER (0...maxNrofUL-Allocations-1-r18)
-- TAG-SERVINGCELLCONFIG-STOP
-- ASN1STOP
```

In some aspects, one example of a DCI format 0_3 is specified in Section 7.3.1.1.4 of 3GPP TS 38.212 v18.6.0.

In some aspects, the DCI for scheduling of multiple PUSCHs in multiple cells with one PUSCH per cell includes a time domain resource assignment (TDRA) field. In some aspects, the number of bits of the TDRA fields is based on a number of entries in the higher layer parameter tdra-FieldIndexListDCI-0-3. In some aspects, the TDRA field indicates an entry in a TDRA configuration or a configured. For example, the TDRA field may indicate an entry in tdra-FieldIndexListDCI-0-3 according to a TDRA table. For example, the TDRA bits may map to an index in a TDRA table, where the index maps to a TDRA configuration (e.g., an entry in tdra-FieldIndexListDCI-0-3). In some aspects, the indexes are mapped in ascending order to entries in the TDRA configuration (e.g., index 0 maps to the first entry in tdra-FieldIndexListDCI-0-3, index 1 maps to the second entry in tdra-FieldIndexListDCI-0-3, and so on). Each index to a TDRA configuration (e.g., entry in tdra-FieldIndexListDCI-0-3) may contain a TDRA index for each BWP of each cell in the scheduled cell set.

In some aspects, the DCI for scheduling of multiple PUSCHs in multiple cells with one PUSCH per cell may further include, in addition to the TDRA field, one or more of the following fields: a DCI format indicator; a scheduled cell set indicator (e.g., indicating a cell from MC-DCI-SetofCells) which may indicate a set of cells to be scheduled by the DCI (where the set of cells may be configured by mc-DCI-SetofCellsToAddModList); a scheduled cells indicator; a bandwidth part (BWP) indicator indicating scheduled BWPs of a scheduled cell; a frequency domain resource assignment (FDRA); a frequency hopping flag; a modulation and coding scheme (MCS) field; a new data indicator (NDI); a redundancy version (RV); a hybrid automatic repeat request (HARQ) process number; a first downlink assignment index (DAI); a second DAI; a transmit power command (TPC); a sounding reference signal (SRS) resource indicator; precoding information and number of layers; an SRS request; an SRS offset indicator; a channel state information (CSI) request; an antenna ports field; a phase tracking reference signal (PTRS)-demodulation reference signal (DMRS) association; a beta offset indicator; an uplink shared channel (UL-SCH) indicator; a channel access field; an open-loop power control parameter set indication; a priority indicator; a minimum applicable scheduling offset indicator; a second cell (SCell) dormancy indication; and/or a physical downlink control channel (PDCCH) monitoring adaptation indication.

In some aspects, an example of the DCI format 1_3 is specified in Section 7.3.1.2.4 of 3GPP TS 38.212 v18.6.0.

In some aspects, the DCI for scheduling of multiple PDSCHs in multiple cells with one PDSCH per cell may include, in addition to a TDRA field, one or more of the following fields: a DCI format indicator; a scheduled cell set indicator; a scheduled cells indicator; a BWP indicator; a FDRA; a virtual resource block (VRB) to physical resource block (PRB) mapping; a PRB bundling size indicator; a rate matching indicator; a zero power (ZP) CSI-RS trigger; an MCS, NDI, and RV for a first transport block (TB); an MCS, NDI, and RV for a second TB; a HARQ process number; a DAI; a TPC; a physical uplink control channel (PUCCH) resource indicator; a PDSCH-to-HARQ feedback timing indicator; a one-shot HARQ request; an enhanced Type 3 codebook indicator; a HARQ-ACK retransmission indicator; an antenna ports field; a transmission configuration indication (TCI); an SRS request; an SRS offset indicator; a DMRS initialization; a priority indicator; a channel access field; a minimum applicable scheduling offset indicator; an SCell dormancy indication; a PDCCH monitoring adaptation indication; and/or a PUCCH cell indicator.

In some aspects, the UE receiving the DCI can determine the scheduled cells, the scheduled PDSCH or PUSCH transmission in each cell, and the associated TDRA.

### Aspects Related to Multi-Transmission Scheduling Configuration

In certain systems, multiple transmissions (multi-transmission) can be scheduled in one cell. In some examples, multiple physical downlink shared channel (PDSCH) or physical uplink shared channel (PUSCH) transmission can be scheduled in a cell.

In some aspects, a TDRA table is configured for the multi-transmission in a cell. In some aspects, a user equipment (UE) is configured via higher layer signaling with the TDRA table for the multi-transmission in a cell. In some aspects, the UE is configured via a radio resource control (RRC) information element (IE) with the TDRA table for the multi-transmission in a cell. In one example, the TDRA table for multi-PDSCH in a cell is configured via a PDSCH configuration RRC IE (e.g., PDSCH-Config). In one example, the TDRA table for multi-PUSCH in a cell is configured via a PUSCH configuration RRC IE (e.g., PUSCH-Config). It should be understood that while aspects herein are described with respect to the example of downlink PDSCH configuration, the aspects apply equally for uplink PUSCH configuration.

One example of an RRC PDSCH configuration and RRC PSCH configuration are specified in Section 6.3.2 of 3GPP TS 38.331 v18.5.1. In some aspects, the RRC PDSCH configuration includes a parameter (e.g., pdsch-TimeDomainAllocationListForMulti PDSCH) configures a list of allocations (e.g., MultiPDSCH-TDRA) for multi-PDSCH transmissions in a cell. The parameter may configure a list of allocations for up to a maximum number of downlink allocations (e.g., maxNrofDL-AllocationsExt). Each allocation may configure a list of TDRA indexes (e.g., pdsch-TDRA-List) for that allocation. Each TDRA index maps to a set of one or more TDRAs (e.g., PDSCH-TimeDomainResourceAllocation). A TDRA index may map to up to a maximum number of TDRAs (e.g., maxNrofMultiplePDSCHs) that can be associated with a same TDRA index, or a maximum number of PDSCHs that can be transmitted in a cell. The TDRA (e.g., PDSCH-Time DomainResourceAllocation) may configure a time domain relation between PDCCH and PDSCH.

One example below is an example portion of an RRC PDSCH TDRA allocation configuration IE:

```
-- ASN1START
-- TAG-PDSCH-TIMEDOMAINRESOURCEALLOCATIONLIST-START
PDSCH-TimeDomainResourceAllocationList ::= SEQUENCE (SIZE(1...maxNrofDL-
Allocations)) OF PDSCH-TimeDomainResourceAllocation
PDSCH-TimeDomainResourceAllocation ::= SEQUENCE {
        k0 INTEGER(0...32) OPTIONAL, -- Need S
        mappingType ENUMERATED {typeA, typeB},
        startSymbolAndLength INTEGER (0...127)
}
...
MultiPDSCH-TDRA-List-r17 ::= SEQUENCE (SIZE(1...maxNrofDL-AllocationsExt-
r17)) OF MultiPDSCH-TDRA-r17
MultiPDSCH-TDRA-r17 ::= SEQUENCE {
        pdsch-TDRA-List-r17 SEQUENCE (SIZE(1...maxNrofMultiplePDSCHs
-r17)) OF PDSCH-TimeDomainResourceAllocation-r16,
...
}
-- TAG-PDSCH-TIMEDOMAINRESOURCEALLOCATIONLIST-STOP
-- ASN1STOP
```

The network may indicate in the downlink assignment (e.g., in DCI) which of the configured time domain allocations the UE shall apply for that downlink assignment.

### Aspects Related to Multi-Cell Multi-Transmission Configuration and Signaling

Aspects of the present disclosure provide time domain resource allocation (TDRA) configuration and signaling for multiple cell (multi-cell) multiple-transmission (multi-transmission) joint scheduling, in which multiple cells are scheduled and in which multiple transmissions can be scheduled in one cell of the multiple cells.

In some aspects, the multiple transmissions can be scheduled across multiple cells, and bandwidth parts (BWPs), configured with different subcarrier spacing (SCS) or with the same SCS.

### Multi-Cell RRC Configuration on Top of Multi-Transmission TDRA Tables:

According to certain aspects, for configuring multi-cell multi-transmission joint scheduling, a user equipment (UE) may receiving signaling configuring a set of TDRAs per BWP for each cell of multiple cells, a set of multi-PDSCH or multi-PUSCH TDRA tables. Accordingly, a multi-cell configuration may be added on top of a multi-PDSCH or multi-PUSCH configuration.

In some aspects, the signaling configures a list of one or more multi-transmission TDRA allocations. For example, for downlink and uplink, radio resource control (RRC) parameters (e.g., a new parameter referred to, for example, as MC-MultiPDSCH-TDRA-List for downlink and MC-MultiPUSCH-TDRA-List for uplink) may configure the list of one or more multi-transmission TDRA allocations for each configured BWP in each configured cell. In some aspects, the parameter configures a list of up to specified maximum number (e.g., 1 . . . 256) of multi-transmission TDRA allocations (e.g., a new parameter referred to, for example, as MC-MultiPDSCH-TDRA for downlink and for MC-MultiPUSCH-TDRA uplink). In some aspects, the parameter configuring the list of one or more multi-transmission TDRA allocations may be signaled via an RRC reconfiguration message (e.g., RRCReconfiguration). In some aspects, the parameter configuring the list of one or more multi-transmission TDRA allocations may be signaled via a physical downlink shared channel (PDSCH) configuration IE (PDSCH-Config) and/or a physical uplink shared channel (PUSCH) configuration IE (PUSCH-Config) in an RRC reconfiguration message.

In some aspects, the signaling configures, for each multi-transmission TDRA allocation (e.g., MC-MultiPDSCH-TDRA, MC-MultiPUSCH-TDRA), of the list of one or more multi-transmission TDRA allocations, a list of one or more TDRA indexes (e.g., MultiPDSCH-TDRA, MultiPUSCH-TDRA) for each PDSCH and/or PUSCH scheduled in each BWP of each configured cell. In some aspects, the list of one or more TDRA index configures a number of TDRA indexes up to maximum number of BWPs in a set of cells (e.g., 1 . . . maxNrofBWPsInSetofCells-DCI-1-3 for downlink and 1 . . . maxNrofBWPsInSetof Cells-DCI-0-3 for uplink).

In some aspects, the signaling configures, for each TDRA index (e.g., MultiPDSCH-TDRA, MultiPUSCH-TDRA), of the list of one or more TDRA indexes, a set of one or more transmission allocation lists (e.g., pdsch-TDRA-List, pusch-TDRA-List). In some aspects, entries in the TDRA index may be ordered in ascending order of BWP ID (e.g., BWP-Id) for the first cell, then in ascending order of BWP ID for the second cell, and so on.

In some aspects, the signaling configures each transmission allocation list (e.g., pdsch-TDRA-List, pusch-TDRA-List), of the set of one or more transmission allocation lists, a list of TDRAs (e.g., PDSCH-TimeDomainResource Allocation, PUSCH-TimeDomainResourceAllocation). In some aspects, the list of TDRAs configures up to a specified maximum number of TDRAs. In some aspects, the list of TDRAs configures up to a maximum number (e.g., 1 . . . maxNrofMultiplePDSCHs, 1 . . . maxNrofMultiple PUSCHs) of TDRAs associated with a same TDRA index, or of transmissions that can be transmitted in a same cell.

### RRC Payload Reduction:

According to certain aspects, a payload for configuring the multi-cell multi-transmission TDRA configuration may be reduced. For example, because multiple cells and multiple transmissions may be scheduled, the RRC signaling overhead may scale in size considerably depending on the amount of flexibility configured (e.g. more flexibility require more entries in the TDRA table to be configured).

To reduce the size of the RRC payload, the signaled multi-transmission TDRA allocations (e.g., MC-MultiPDSCH-TDRA, MC-MultiPUSCH-TDRA) may be signaled such the BWPs configured for a given cell that have the same SCS use the same set of entries (e.g., MultiPDSCH-TDRA, MultiPUSCH-TDRA). For example, the multi-transmission TDRA allocation may signal a list of TDRA indexes for each BWP of each cell, up to a maximum number of different SCSs (e.g., up to 1 . . . maxNrofSCSBWPsInSetofCells-DCI-1-3 MultiPDSCH-TDRAs for MC-MultiPDSCH-TDRA, and up to 1 . . . maxNrofSCSBWPsInSetofCells-DCI-0-3 MultiPUSCH-TDRAs for MC-MultiPUSCH-TDRA). In some aspects, the maximum number may be specified or signaled to the UE. In some aspects, entries in the TDRA index may be ordered in ascending order of SCS for the first cell, then in ascending order of SCS for the second cell, and so on.

Accordingly, the network may signal, for each cell the TDRA allocation for as many BWPs with distinct SCS configured for that particular cell, so that any two or more BWPs configured for a given cell that have the same SCS may have the same TDRA configuration tables and, for a particular SCS, the TDRA configurations across cells is separately signaled. As an illustrative example, for a first cell (Cell 1) configured with three BWPs have the SCS configurations: BWP1 with 15 kHz SCS, BWP2 with 15 kHz SCS, and BWP3 with 30 kHz SCS, the BWP1 and BWP2 having the same SCS are configured with the same TDRA table (TDRA1) and the BWP3 is configured with a second TDRA table (TDRA2). As another example, for a second cell (Cell 2) with three BWPs having the SCS configurations: BWP 1 with 30 kHz SCS, BWP 2 with 30 kHz SCS, BWP 3 with 15 kHz SCS, the BWP 1 and BWP2 having the same SCS are configured with the same TDRA table (TDRA3) and the BWP3 is configured with another TDRA table (TDRA4).

According to certain aspects, based on the RRC configured TDRA configuration, the network can signal TDRAs to the UE for multi-cell multi-transmission scheduling. In some aspects, the network signals the TDRAs to the UE via DCI. In some aspects, the network signals the TDRAs for multi-cell multi-PDSCH scheduling via a DCI format 1_3. In some aspects, the network signals the TDRAs for multi-cell multi-PUSCH scheduling via a DCI format 0_3.

According to certain aspects, the DCI indicates one of the multi-transmission TDRA indexes (e.g., MultiPDSCH-TDRA, MultiPUSCH-TDRA) from the TDRA allocation (e.g., MC-MultiPDSCH-TDRA, MC-MultiPUSCH-TDRA). The UE uses the entries (e.g., pdsch-TDRA-List, pusch-TDRA-List) in the TDRA indexes corresponding to the BWPs for the scheduled cells to determine the TDRAs (e.g., PDSCH-TimeDomainResourceAllocation, PUSCH-TimeDomainResourceAllocation) to use for transmitting PUSCH transmissions or receiving PDSCH transmissions in the respective BWPs of respective cells.

### Reversed-Hierarchy Multi-Cell RRC Configuration on Top of Multi-Transmission TDRA Tables:

According to certain aspects, a hierarchy of the multi-cell multi-transmission TDRA configuration may be reversed. In some examples, the TDRA allocations may be signaled first for multiple transmissions, and then for each configured BWP in each cell. For example, the multi-transmission TDRA allocation (e.g., MC-MultiPDSCH-TDRA, MC-MultiPUSCH-TDRA) may configure a number of TDRA indexes (e.g., TDRA-MC-DCI-1-3 for downlink, and TDRA-MC-DCI-0-3 for uplink) up to a maximum number (e.g., 1 . . . maxNrofMultiplePDSCHs or 1 . . . maxNrofMultiplePUSCHs) of transmissions that can be scheduled in a cell. In this case, the TDRA index may configure a list of indices (e.g., INTEGER) of up to a maximum number of BWPs (e.g., 1 . . . maxNrofBWPsInSetOfCells-DCI-1-3 for downlink, and 1 . . . maxNrofBWPsInSetOf Cells-DCI-0-3 for uplink), each of the indices from up to a maximum number of allocations (e.g., 0 . . . maxNrofDL-Allocations-1 for downlink and 0 . . . maxNrofDL-Allocations-1 for uplink).

The maximum number of the list of multi-transmission TDRA allocations (e.g., 256) may represent the total possible combinations of multi-transmission scheduling over the different BWPs in the multiple cells.

### Multi-Transmission RRC Configuration on Top of Multi-Cell TDRA Configuration

According to certain aspects, for configuring multi-cell multi-transmission joint scheduling, a UE may receiving signaling configuring, for one or more multi-PDSCH or multi-PUSCH transmission allocations, a set of multi-cell TDRA tables. Accordingly, a multi-transmission configuration may be added on top of a multi-cell TDRA configuration.

In some aspects, the signaling configures a list of one or more multi-transmission TDRA allocations. For example, for downlink and uplink, RRC parameters (e.g., a new parameter referred to, for example, as tdra-FieldIndexListDCI-1-3 for downlink and tdra-FieldIndexListDCI-0-3 for uplink) may configure a list of one or more DCI TDRA field indexes (e.g., a new parameter referred to, for example, as TDRA-FieldIndexDCI-1-3 for downlink and TDRA-FieldIndexDCI-0-3 for uplink) for each configured transmission allocation in each BWP of each configured cell (e.g., of MultiPDSCH-TDRA). In some aspects, the parameter configures a list of up to a specified maximum number (e.g., 1 . . . 256) of DCI TDRA field indexes.

In some aspects, the parameter configuring the list of one or more multi-transmission TDRA allocations may be signaled via an RRC reconfiguration message (e.g., RRCReconfiguration). In some aspects, the parameter configuring the list of one or more multi-transmission TDRA allocations may be signaled via a serving cell configuration IE (ServingCellConfig).

In some aspects, each DCI field index, of the one or more DCI field indexes, configures a list of TDRA indexes (e.g., MultiPDSCH-TDRA, MultiPUSCH-TDRA). In some aspects, each list of TDRA indexes may include a TDRA index for each BWP of each cell of the multiple cells up to a specified maximum number of BWPs (e.g., 2 . . . maxNrofBWPsInSetofCells). Each TDRA index (e.g., MultiPDSCH-TDRA, MultiPUSCH-TDRA) entry may contain a list of TDRAs for each transmission scheduled in each BWP of each configured cell

In some aspects, each TDRA index, of the list of TDRA indexes, configures a set of transmission allocations (e.g., INTEGER of 0 . . . maxNrofDL-Allocations for downlink and 0 . . . maxNrofUL-Allocations for uplink). In some aspects, each TDRA index configures up to a number of transmission allocations up to a specified maximum number of TDRAs associated with a same TDRA index or maximum number of transmissions scheduled in a cell (e.g., 1 . . . maxNrofMultiplePDSCHs for downlink or 1 . . . maxNrof MultiplePUSCHs for uplink).

Accordingly, the network may signal, for each cell the TDRA allocation for as many BWPs with distinct SCS configured for that particular cell, so that any two or more BWPs configured for a given cell that have the same SCS may have the same TDRA configuration tables and, for a particular SCS, the TDRA configurations across cells is separately signaled.

### Reversed-Hierarchy Multi-Transmission RRC Configuration on Top of Multi-Cell TDRA RRC Configuration:

According to certain aspects, a hierarchy of the multi-cell multi-transmission TDRA configuration may be reversed. In some examples, the TDRA allocations may be signaled first for multiple transmissions, and then for each configured BWP in each cell. For example, the RRC parameter (e.g., tdra-FieldIndexListDCI-1-3, tdra-FieldIndexList DCI-0-3) may configure a list of one or more DCI TDRA field index allocations (e.g., MultiTDRA-FieldIndexDCI-1-3 for downlink and MultiTDRA-FieldIndexDCI-0-3 for uplink). Each DCI TDRA field index allocation may configure a list of DCI TDRA field indexes (e.g., TDRA-FieldIndexDCI-1-3, TDRA-FieldIndexDCI-0-3) for up to a maximum number of transmission allocations (e.g., 1 . . . maxNrofMultiplePDSCHs, 1 . . . maxNrofMultiplePUSCHs). EACH DCI TDRA field index may configure a number of allocations (e.g., INTEGER of 0 . . . maxNrofDL-Allocations-1, 0 . . . maxNrofUL-Allocations-1) for up to a maximum number of BWPs (e.g., 2 . . . maxNrofBWPsInSetOfCells).

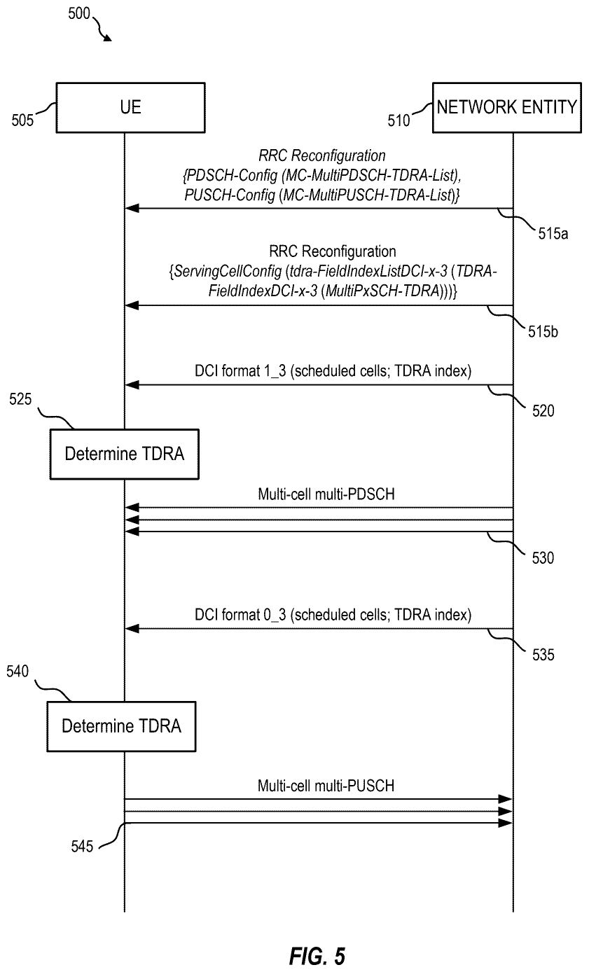

FIG. 5 depicts a process flow 500 for communications in a network between a network entity 510 and a UE 505. In some aspects, the network entity 510 may be an example of the BS 102 depicted and described with respect to FIGS. 1 and 3 or a disaggregated base station depicted and described with respect to FIG. 2. Similarly, the UE 505 may be an example of UE 104 depicted and described with respect to FIGS. 1 and 3. However, in other aspects, UE 505 may be another type of wireless communications device and network entity 510 may be another type of network entity or network node, such as those described herein.

As shown in FIG. 5, at 515a, the network entity 510 may signal the UE 505 an RRC Reconfiguration message which includes a PDSCH configuration IE and/or a PUSCH configuration IE, in which the PDSCH configuration IE and/or PUSCH configuration IE carry parameters (MC-MultiPDSCH-TDRA-List and MC-MultiPUSCH-TDRA-List, respectively) configuring the multi-cell multi-transmission TDRA configuration.

As shown in FIG. 5, at 515b, the RRC Reconfiguration message may include a serving cell configuration IE carrying parameters (tdra-FieldIndexListDCI-x-3, DTRA-FieldIndexDCI-x-3, MultiPxSCH-TDRA, respectively, where ‘x’ indicates the parameter can be the uplink parameter or the downlink parameter) configuring the multi-cell multi-transmission TDRA configuration.

At 520, the network entity 510 may send the UE 505 a DCI format 1_3 scheduling multi-cell multi-PDSCH transmissions. For example, the DCI may carry an indication of the scheduled cells and the TDRA index.

At 525, the UE 505, after receiving the DCI, can determine the TDRAs for monitoring the scheduled multi-cell multi-PDSCH transmissions based on the TDRA index in the DCI and based on the RRC configuration.

At 530, the network entity 510 transmits and the UE 505 monitors for the multi-cell multi-PDSCH transmissions based on the determined TDRAs.

At 535, the network entity 510 may send the UE 505 a DCI format 0_3 scheduling multi-cell multi-PUSCH transmissions. For example, the DCI may carry an indication of the scheduled cells and the TDRA index.

At 540, the UE 505, after receiving the DCI, can determine the TDRAs for transmitting the scheduled multi-cell multi-PUSCH transmissions based on the TDRA index in the DCI and based on the RRC configuration.

At 545, the network entity 510 monitors and the UE 505 transmits the multi-cell multi-PUSCH transmissions based on the determined TDRAs.

### Example Operations by a User Equipment

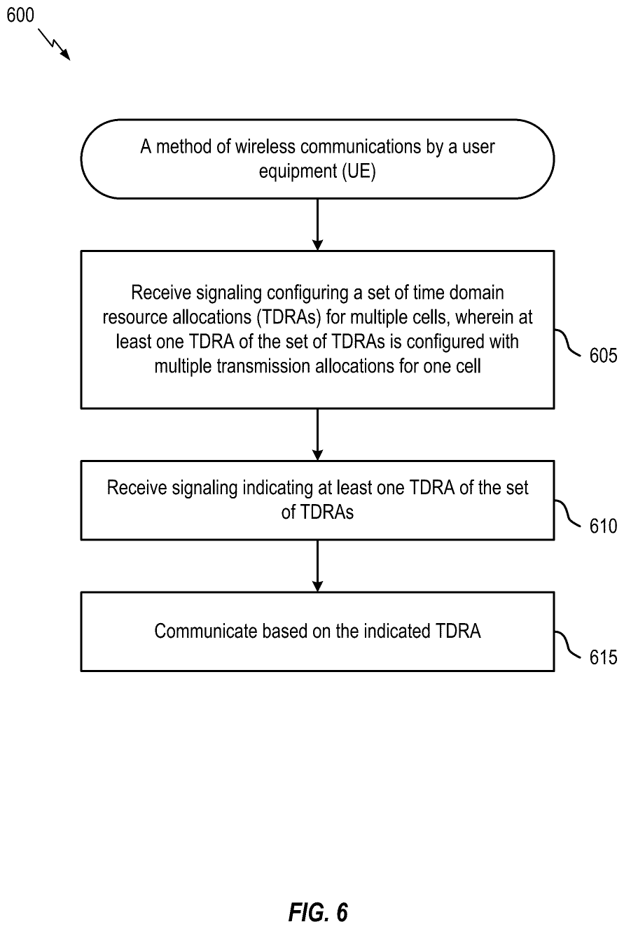

FIG. 6 shows an example of a method 600 of wireless communications by a user equipment (UE), such as a UE 104 of FIGS. 1 and 3.

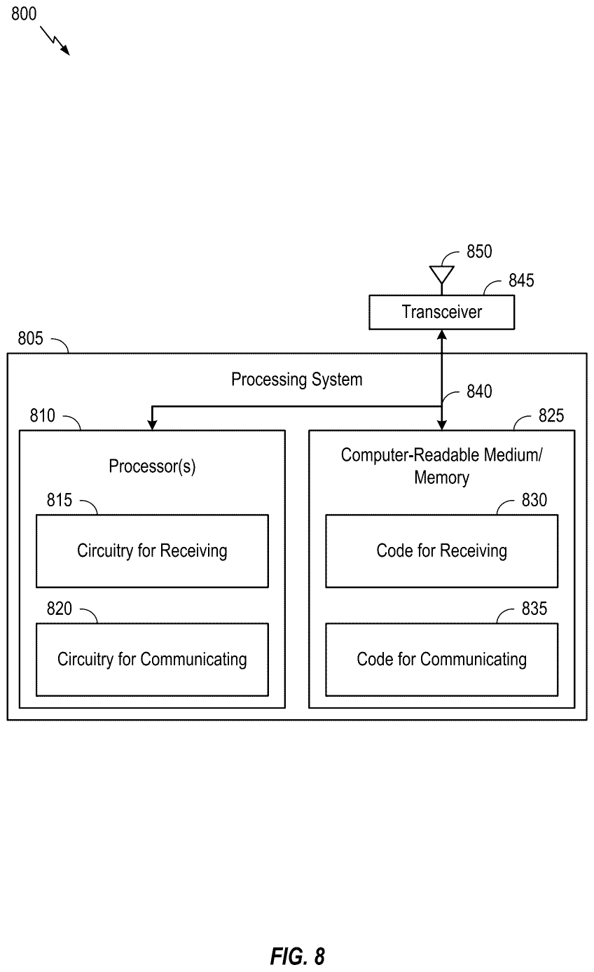

Method 600 begins at step 605 with receiving signaling configuring a set of time domain resource allocations (TDRAs) for multiple cells, wherein at least one TDRA of the set of TDRAs is configured with multiple transmission allocations for one cell. In some cases, the operations of this step refer to, or may be performed by, circuitry for receiving and/or code for receiving as described with reference to FIG. 8.

Method 600 then proceeds to step 610 with receiving signaling indicating at least one TDRA of the set of TDRAs. In some cases, the operations of this step refer to, or may be performed by, circuitry for receiving and/or code for receiving as described with reference to FIG. 8.

Method 600 then proceeds to step 615 with communicating based on the indicated TDRA. In some cases, the operations of this step refer to, or may be performed by, circuitry for communicating and/or code for communicating as described with reference to FIG. 8.

In some aspects, the receiving of the signaling at step 605 configuring the set of TDRAs comprises receiving signaling configuring, for each cell of the multiple cells, a set of multiple physical downlink shared channel (multi-PDSCH) or multiple physical uplink shared channel (multi-PUSCH) TDRA tables.

In some aspects, the receiving of the signaling at step 605 configuring the set of TDRAs comprises receiving per bandwidth part (BWP), the signaling configuring, for each cell of the multiple cells, the set of multi-PDSCH or multi-PUSCH TDRA tables.

In some aspects, the receiving of the signaling at step 605 configuring the set of TDRAs comprises receiving signaling configuring: a list of one or more multi-transmission TDRA allocations; for each multi-transmission TDRA allocation, of the list of one or more multi-transmission TDRA allocations, a list of one or more TDRA indexes; for each TDRA index, of the list of one or more TDRA indexes, a set of one or more transmission allocation lists; and each transmission allocation list, of the set of one or more transmission allocation lists, a list of TDRAs.

In some aspects, the receiving of the signaling at step 605 configuring the set of TDRAs comprises receiving a radio resource configuration (RRC) physical downlink shared channel (PDSCH) configuration information element (IE) or a physical uplink shared channel (PUSCH) configuration IE indicating the list of the one or more multi-transmission TDRA allocations.

In some aspects, each list of one or more multi-transmission TDRA allocations comprises up to a specified maximum number of multi-transmission TDRA allocations.

In some aspects, the specified maximum number of allocations is 256.

In some aspects, each list of one or more TDRA indexes comprises a TDRA index for each bandwidth part (BWP) of each cell of the multiple cells up to a specified maximum number of BWPs.

In some aspects, each list of TDRAs comprises up to a specified maximum number of TDRAs associated with a same TDRA index.

In some aspects, for each cell of the multiple cells, the list of TDRA indexes comprises a TDRA index for each bandwidth part (BWP), having different subcarrier spacing (SCS), of the cell up to a specified maximum number of different SCSs for BWPs of the cell.

In some aspects, the method 600 further includes receiving signaling configuring the specified maximum number of different SCS or BWPs of the cell. In some cases, the operations of this step refer to, or may be performed by, circuitry for receiving and/or code for receiving as described with reference to FIG. 8.

In some aspects, the receiving of the signaling at step 610 indicating at least one TDRA of the set of TDRAs comprises receiving a downlink control information (DCI) indicating an allocation of the list of allocations.

In some aspects, the DCI comprises a DCI format 0_3 or a DCI format 1_3.

In some aspects, each list of TDRA indexes comprises a TDRA index for up to a specified maximum number of transmission allocations associated with a same TDRA index of transmission allocations.

In some aspects, each list of TDRAs comprises up to a specified maximum number of transmission allocations per bandwidth part (BWP) of a cell.

In some aspects, the receiving of the signaling at step 605 configuring the set of TDRAs comprises receiving signaling configuring, for one or more multiple physical downlink shared channel (multi-PDSCH) transmission allocations or multiple physical uplink shared channel (multi-PUSCH) transmission allocations, a set of multiple cell TDRA tables.

In some aspects, the receiving of the signaling at step 605 configuring the set of TDRAs comprises receiving signaling configuring: a list of one or more downlink control information (DCI) field indexes; for each DCI field index, of the one or more DCI field indexes, a list of TDRA indexes; and for each TDRA index, of the list of TDRA indexes, a set of transmission allocations.

In some aspects, the receiving of the signaling at step 605 configuring the set of TDRAs comprises receiving a radio resource configuration (RRC) serving cell configuration information element (IE) indicating the list of TDRA indexes.

In some aspects, the list of one or more DCI field indexes comprises up to a specified maximum number of DCI field indexes.

In some aspects, the specified maximum number of DCI field indexes is 256.

In some aspects, each list of TDRA indexes comprises a TDRA index for each bandwidth part (BWP) of each cell of the multiple cells up to a specified maximum number of BWPs.

In some aspects, each set of transmission allocations comprises up to a specified maximum number of transmission allocations associated with a same TDRA index of transmission allocations.

In some aspects, each list of one or more TDRA indexes comprises a TDRA index for each transmission allocation up to a specified maximum number of transmission occasions.

In some aspects, each set of transmission allocations comprises a transmission allocation per bandwidth part (BWP) of each cell, of the multiple cells, up to a specified maximum number of BWPs.

In some aspects, the communicating at step 615 comprises at least one of: transmitting one or more physical uplink shared channel (PUSCH) transmissions in the multiple cells; or receiving one or more physical downlink shared channel (PDSCH) transmissions in the multiple cells.

In one aspect, method 600, or any aspect related to it, may be performed by an apparatus, such as communications device 800 of FIG. 8, which includes various components operable, configured, or adapted to perform the method 600. Communications device 800 is described below in further detail.

Note that FIG. 6 is just one example of a method, and other methods including fewer, additional, or alternative steps are possible consistent with this disclosure.

### Example Operation by a Network Entity

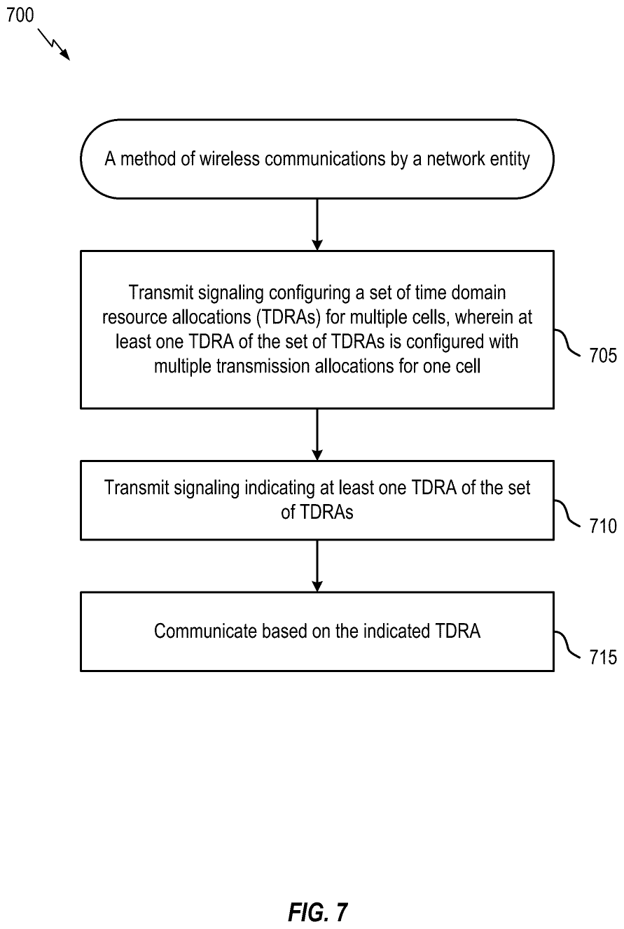

FIG. 7 shows an example of a method 700 of wireless communications by a network entity, such as a BS 102 of FIGS. 1 and 3, or a disaggregated base station as discussed with respect to FIG. 2.

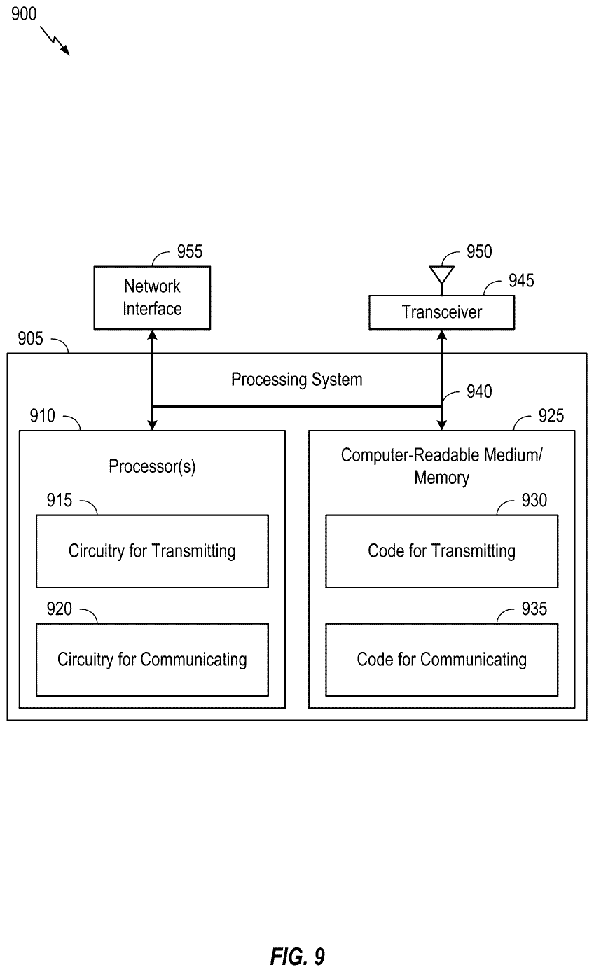

Method 700 begins at step 705 with transmitting signaling configuring a set of time domain resource allocations (TDRAs) for multiple cells, wherein at least one TDRA of the set of TDRAs is configured with multiple transmission allocations for one cell. In some cases, the operations of this step refer to, or may be performed by, circuitry for transmitting and/or code for transmitting as described with reference to FIG. 9.

Method 700 then proceeds to step 710 with transmitting signaling indicating at least one TDRA of the set of TDRAs. In some cases, the operations of this step refer to, or may be performed by, circuitry for transmitting and/or code for transmitting as described with reference to FIG. 9.

Method 700 then proceeds to step 715 with communicating based on the indicated TDRA. In some cases, the operations of this step refer to, or may be performed by, circuitry for communicating and/or code for communicating as described with reference to FIG. 9.

In some aspects, the transmitting of the signaling at step 705 configuring the set of TDRAs comprises transmitting signaling configuring, for each cell of the multiple cells, a set of multiple physical downlink shared channel (multi-PDSCH) or multiple physical uplink shared channel (multi-PUSCH) TDRA tables.

In some aspects, the transmitting of the signaling at step 705 configuring the set of TDRAs comprises transmitting per bandwidth part (BWP), the signaling configuring, for each cell of the multiple cells, the set of multi-PDSCH or multi-PUSCH TDRA tables.

In some aspects, the transmitting of the signaling at step 705 configuring the set of TDRAs comprises transmitting signaling configuring: a list of one or more multi-transmission TDRA allocations; for each multi-transmission TDRA allocation, of the list of one or more multi-transmission TDRA allocations, a list of one or more TDRA indexes; for each TDRA index, of the list of one or more TDRA indexes, a set of one or more transmission allocation lists; and each transmission allocation list, of the set of one or more transmission allocation lists, a list of TDRAs.

In some aspects, the transmitting of the signaling at step 705 configuring the set of TDRAs comprises transmitting a radio resource configuration (RRC) physical downlink shared channel (PDSCH) configuration information element (IE) or a physical uplink shared channel (PUSCH) configuration IE indicating the list of the one or more multi-transmission TDRA allocations.

In some aspects, each list of one or more multi-transmission TDRA allocations comprises up to a specified maximum number of multi-transmission TDRA allocations.

In some aspects, the specified maximum number of allocations is 256.

In some aspects, each list of one or more TDRA indexes comprises a TDRA index for each bandwidth part (BWP) of each cell of the multiple cells up to a specified maximum number of BWPs.

In some aspects, each list of TDRAs comprises up to a specified maximum number of TDRAs associated with a same TDRA index.

In some aspects, for each cell of the multiple cells, the list of TDRA indexes comprises a TDRA index for each bandwidth part (BWP), having different subcarrier spacing (SCS), of the cell up to a specified maximum number of different SCSs or BWPs of the cell.

In some aspects, the method 700 further includes transmitting signaling configuring the specified maximum number of different SCS or BWPs of the cell. In some cases, the operations of this step refer to, or may be performed by, circuitry for transmitting and/or code for transmitting as described with reference to FIG. 9.

In some aspects, the transmitting of the signaling at step 710 indicating at least one TDRA of the set of TDRAs comprises transmitting a downlink control information (DCI) indicating an allocation of the list of allocations.

In some aspects, the DCI comprises a DCI format 0_3 or a DCI format 1_3.

In some aspects, each list of TDRA indexes comprises a TDRA index for up to a specified maximum number of transmission allocations associated with a same TDRA index of transmission allocations.

In some aspects, each list of TDRAs comprises up to a specified maximum number of transmission allocations per bandwidth part (BWP) of a cell.

In some aspects, the transmitting of the signaling at step 705 configuring the set of TDRAs comprises transmitting signaling configuring, for one or more multiple physical downlink shared channel (multi-PDSCH) transmission allocations or multiple physical uplink shared channel (multi-PUSCH) transmission allocations, a set of multiple cell TDRA tables.

In some aspects, the transmitting of the signaling at step 705 configuring the set of TDRAs comprises transmitting signaling configuring: a list of one or more downlink control information (DCI) field indexes; for each DCI field index, of the one or more DCI field indexes, a list of TDRA indexes; and for each TDRA index, of the list of TDRA indexes, a set of transmission allocations.

In some aspects, the transmitting of the signaling at step 705 configuring the set of TDRAs comprises transmitting a radio resource configuration (RRC) serving cell configuration information element (IE) indicating the list of TDRA indexes.

In some aspects, the list of one or more DCI field indexes comprises up to a specified maximum number of DCI field indexes.

In some aspects, the specified maximum number of DCI field indexes is 256.

In some aspects, each list of TDRA indexes comprises a TDRA index for each bandwidth part (BWP) of each cell of the multiple cells up to a specified maximum number of BWPs.

In some aspects, each set of transmission allocations comprises up to a specified maximum number of transmission allocations associated with a same TDRA index of transmission allocations.

In some aspects, each list of one or more TDRA indexes comprises a TDRA index for each transmission allocation up to a specified maximum number of transmission occasions.

In some aspects, each set of transmission allocations comprises a transmission allocation per bandwidth part (BWP) of each cell, of the multiple cells, up to a specified maximum number of BWPs.

In some aspects, the communicating at step 715 comprises at least one of: receiving one or more physical uplink shared channel (PUSCH) transmissions in the multiple cells; or transmitting one or more physical downlink shared channel (PDSCH) transmissions in the multiple cells.

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure.

### Example Communications Device(s)

FIG. 8 depicts aspects of an example communications device 800. In some aspects, communications device 800 is a user equipment, such as UE 104 described above with respect to FIGS. 1 and 3. Communication device 800 may be capable of transmitting and receiving wireless communications in the form of, for example, wireless packets. For example, communication device 800 may be configurable or configured to transmit and receive signals and communications conforming to one or more 3GPP specifications including those for 5G NR or 6G, among others. Additionally, or alternatively, wireless communication device 800 may be configurable or configured to transmit and receive signals and communications conforming to one or more of the IEEE 802.11 family of wireless communication protocol standards, among others.

The communications device 800 includes a processing system 805 coupled to the transceiver 845 (e.g., a transmitter and/or a receiver). The transceiver 845 is configured to transmit and receive signals for the communications device 800 via the antenna 850, such as the various signals as described herein. The processing system 805 may be configured to perform processing functions for the communications device 800, including processing signals received and/or to be transmitted by the communications device 800. The processing system 805 may be configured to perform PHY layer operations and MAC layer operations, and, in some instances, upper layer operations, associated with transmitting and receiving wireless communications.

In some examples, the communication device 800 may also include at least one other external network interface (not shown) that enables the processing system 805 to communicate with another network (such as a core network, a backhaul network) to gain access to external networks including the Internet. For example, a communication device 800 configured as a UE 104 may also include one or more external network interfaces, such as a WLAN interface, to provide a backhaul.

The processing system 805 includes one or more processors 810. Processing system 805 may include one or more chips, system on chips (SoCs), chipsets, packages, components or devices that individually or collectively constitute the processing system 805. Processing system 805 may interface with other components of a communication device 800 and may generally process information (such as inputs or signals) received from such other components and output information (such as outputs or signals) to such other components.

In various aspects, the one or more processors 810 may be representative of one or more of receive processor 358, transmit processor 364, TX MIMO processor 366, and/or controller/processor 380, as described with respect to FIG. 3. The one or more processors 810 are coupled to a computer-readable medium/memory 825 via a bus 840. In certain aspects, the computer-readable medium/memory 825 is configured to store instructions (e.g., computer-executable code) that when executed by the one or more processors 810, cause the one or more processors 810 to perform the method 600 described with respect to FIG. 6, or any aspect related to it. Note that reference to a processor performing a function of communications device 800 may include one or more processors 810 performing that function of communications device 800.

In the depicted example, computer-readable medium/memory 825 stores code (e.g., executable instructions), such as code for receiving 830 and code for communicating 835. Processing of the code for receiving 830 and code for communicating 835 may cause the communications device 800 to perform the method 600 described with respect to FIG. 6, or any aspect related to it. Computer-readable medium/memory 825 may be implemented in the form of one or more memory devices, memory components, memory blocks, memory elements or other discrete gate or transistor logic or circuitry. Computer-readable medium/memory 825 may include tangible storage media including non-volatile memory, such as read-only memory (ROM), or volatile memory, such as random-access memory (RAM) (such as static RAM (SRAM), dynamic RAM (DRAM), or synchronous DRAM (SDRAM) such as low power double data rate (LPDDR) memory, among other examples, each of which may be generally referred to herein individually as “a memory” or “memory circuitry”) In some examples, processors 810 may be coupled with memory circuitry outside of or distinct from the processing system 805. For example, such additional memory circuitry may include a non-volatile memory storage device such as a solid state drive (SSD), a hard disk drive (HDD), or removable storage media. In some other examples, additional memory circuitry also may include volatile memory such as SRAM, DRAM, SDRAM, LPDDR memory, among other examples.

The one or more processors 810 include circuitry configured to implement (e.g., execute) the code stored in the computer-readable medium/memory 825, including circuitry such as circuitry for receiving 815 and circuitry for communicating 820. Processing with circuitry for receiving 815 and circuitry for communicating 820 may cause the communications device 800 to perform the method 600 described with respect to FIG. 6, or any aspect related to it.

The wireless communication device 800 may further include any additional circuitry or components for the processing system 805 to operate to perform the functions and processes described herein. In some examples, the processing system 805 may further include, be coupled with, or be connected to one or more encoding circuits and decoding circuits (also referred to herein simply as “encoders” and “decoders,” respectively), one or more segment parsing circuits and deparsing circuits (also referred to herein simply as “segment parsers” and “segment deparsers,” respectively), one or more stream parsing circuits and deparsing circuits (also referred to herein simply as “stream parsers” and “stream deparsers,” respectively), and modulation circuits and demodulation circuits or circuitry (not specifically shown). For example, the processing system 805 can include one or more modulation circuits and demodulation circuits in the form of one or more modem chips (also referred to herein simply as “modems”), each including processor circuitry configured for performing modulation or demodulation of wireless communication signals, among other functions associated with PHY layer operations.

In some examples, the modem circuitry, whether implemented internal or external to the processing system 805, may further include, be coupled with, or be connected to one or more RF and analog circuits or circuitry (not specifically shown). In some examples in which the processing system 805 includes modem circuitry, the processing system 805 may include at least some of the RF and analog circuitry. In some other examples, most or all of the RF and analog circuitry is separate from but coupled directly or indirectly with or connected to the processing system 805, such as to the modem circuitry. The RF and analog circuitry can include RF chains or transceiver circuitry (or transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processing system 805) domains.

Various components of the communications device 800 may provide means for performing the method 600 described with respect to FIG. 6, or any aspect related to it. For example, means for transmitting, sending or outputting for transmission may include transceivers 354 and/or antenna(s) 352 of the UE 104 illustrated in FIG. 3 and/or the transceiver 845 and the antenna 850 of the communications device 800 in FIG. 8. Means for receiving or obtaining may include transceivers 354 and/or antenna(s) 352 of the UE 104 illustrated in FIG. 3 and/or the transceiver 845 and the antenna 850 of the communications device 800 in FIG. 8.

FIG. 9 depicts aspects of an example communications device 900. In some aspects, communications device 900 is a network entity, such as BS 102 of FIGS. 1 and 3, or a disaggregated base station as discussed with respect to FIG. 2.

The communications device 900 includes a processing system 905 coupled to the transceiver 945 (e.g., a transmitter and/or a receiver) and/or a network interface 955. The transceiver 945 is configured to transmit and receive signals for the communications device 900 via the antenna 950, such as the various signals as described herein. The network interface 955 is configured to obtain and send signals for the communications device 900 via communication link(s), such as a backhaul link, midhaul link, and/or fronthaul link as described herein, such as with respect to FIG. 2. The processing system 905 may be configured to perform processing functions for the communications device 900, including processing signals received and/or to be transmitted by the communications device 900.

The processing system 905 includes one or more processors 910. In various aspects, one or more processors 910 may be representative of one or more of receive processor 338, transmit processor 320, TX MIMO processor 330, and/or controller/processor 340, as described with respect to FIG. 3. The one or more processors 910 are coupled to a computer-readable medium/memory 925 via a bus 940. In certain aspects, the computer-readable medium/memory 925 is configured to store instructions (e.g., computer-executable code) that when executed by the one or more processors 910, cause the one or more processors 910 to perform the method 700 described with respect to FIG. 7, or any aspect related to it. Note that reference to a processor of communications device 900 performing a function may include one or more processors 910 of communications device 900 performing that function.

In the depicted example, the computer-readable medium/memory 925 stores code (e.g., executable instructions), such as code for transmitting 930 and code for communicating 935. Processing of the code for transmitting 930 and code for communicating 935 may cause the communications device 900 to perform the method 700 described with respect to FIG. 7, or any aspect related to it.

The one or more processors 910 include circuitry configured to implement (e.g., execute) the code stored in the computer-readable medium/memory 925, including circuitry such as circuitry for transmitting 915 and circuitry for communicating 920. Processing with circuitry for transmitting 915 and circuitry for communicating 920 may cause the communications device 900 to perform the method 700 described with respect to FIG. 7, or any aspect related to it.

Various components of the communications device 900 may provide means for performing the method 700 described with respect to FIG. 7, or any aspect related to it. Means for transmitting, sending or outputting for transmission may include transceivers 332 and/or antenna(s) 334 of the BS 102 illustrated in FIG. 3 and/or the transceiver 945 and the antenna 950 of the communications device 900 in FIG. 9. Means for receiving or obtaining may include transceivers 332 and/or antenna(s) 334 of the BS 102 illustrated in FIG. 3 and/or the transceiver 945 and the antenna 950 of the communications device 900 in FIG. 9.

### Example Clauses

Implementation examples are described in the following numbered clauses:

Clause 1: A method of wireless communications by a user equipment (UE), comprising: receiving signaling configuring a set of time domain resource allocations (TDRAs) for multiple cells, wherein at least one TDRA of the set of TDRAs is configured with multiple transmission allocations for one cell; receiving signaling indicating at least one TDRA of the set of TDRAs; and communicating based on the indicated TDRA.

Clause 2: The method of Clause 1, wherein the receiving of the signaling configuring the set of TDRAs comprises receiving signaling configuring, for each cell of the multiple cells, a set of multiple physical downlink shared channel (multi-PDSCH) or multiple physical uplink shared channel (multi-PUSCH) TDRA tables.

Clause 3: The method of any combination of Clauses 1-2, wherein the receiving of the signaling configuring the set of TDRAs comprises receiving per bandwidth part (BWP), the signaling configuring, for each cell of the multiple cells, the set of multi-PDSCH or multi-PUSCH TDRA tables.

Clause 4: The method of any combination of Clauses 1-3, wherein the receiving of the signaling configuring the set of TDRAs comprises receiving signaling configuring: a list of one or more multi-transmission TDRA allocations; for each multi-transmission TDRA allocation, of the list of one or more multi-transmission TDRA allocations, a list of one or more TDRA indexes; for each TDRA index, of the list of one or more TDRA indexes, a set of one or more transmission allocation lists; and each transmission allocation list, of the set of one or more transmission allocation lists, a list of TDRAs.

Clause 5: The method of Clause 4, wherein the receiving of the signaling configuring the set of TDRAs comprises receiving a radio resource configuration (RRC) physical downlink shared channel (PDSCH) configuration information element (IE) or a physical uplink shared channel (PUSCH) configuration IE indicating the list of the one or more multi-transmission TDRA allocations.

Clause 6: The method of any combination of Clauses 4-5, wherein each list of one or more multi-transmission TDRA allocations comprises up to a specified maximum number of multi-transmission TDRA allocations.

Clause 7: The method of Clause 6, wherein the specified maximum number of allocations is 256.

Clause 8: The method of Clause 4, wherein each list of one or more TDRA indexes comprises a TDRA index for each bandwidth part (BWP) of each cell of the multiple cells up to a specified maximum number of BWPs.

Clause 9: The method of any combination of Clauses 4-8, wherein each list of TDRAs comprises up to a specified maximum number of TDRAs associated with a same TDRA index.

Clause 10: The method of any combination of Clauses 1-9, wherein, for each cell of the multiple cells, a list of TDRA indexes comprises a TDRA index for each bandwidth part (BWP), having different subcarrier spacing (SCS), of the cell up to a specified maximum number of different SCSs or BWPs of the cell.

Clause 11: The method of Clause 10, further comprising receiving signaling configuring the specified maximum number of different SCS or BWPs of the cell.

Clause 12: The method of any combination of Clauses 4-11, wherein the receiving of the signaling indicating at least one TDRA of the set of TDRAs comprises receiving a downlink control information (DCI) indicating an allocation of the list of allocations.

Clause 13: The method of Clause 12, wherein the DCI comprises a DCI format 0_3 or a DCI format 1_3.

Clause 14: The method of any combination of Clauses 4-13, wherein each list of TDRA indexes comprises a TDRA index for up to a specified maximum number of transmission allocations associated with a same TDRA index of transmission allocations.

Clause 15: The method of any combination of Clauses 4-14, wherein each list of TDRAs comprises up to a specified maximum number of transmission allocations per bandwidth part (BWP) of a cell.

Clause 16: The method of any combination of Clauses 1-15, wherein the receiving of the signaling configuring the set of TDRAs comprises receiving signaling configuring, for one or more multiple physical downlink shared channel (multi-PDSCH) transmission allocations or multiple physical uplink shared channel (multi-PUSCH) transmission allocations, a set of multiple cell TDRA tables.

Clause 17: The method of Clause 1, 2, 10, or 11, wherein the receiving of the signaling configuring the set of TDRAs comprises receiving signaling configuring: a list of one or more downlink control information (DCI) field indexes; for each DCI field index, of the one or more DCI field indexes, a list of TDRA indexes; and for each TDRA index, of the list of TDRA indexes, a set of transmission allocations.

Clause 18: The method of Clause 17, wherein the receiving of the signaling configuring the set of TDRAs comprises receiving a radio resource configuration (RRC) serving cell configuration information element (IE) indicating the list of TDRA indexes.

Clause 19: The method of any combination of Clauses 17-18, wherein the list of one or more DCI field indexes comprises up to a specified maximum number of DCI field indexes.

Clause 20: The method of Clause 19, wherein the specified maximum number of DCI field indexes is 256.

Clause 21: The method of any combination of Clauses 17-20, wherein each list of TDRA indexes comprises a TDRA index for each bandwidth part (BWP) of each cell of the multiple cells up to a specified maximum number of BWPs.

Clause 22: The method of any combination of Clauses 17-21, wherein each set of transmission allocations comprises up to a specified maximum number of transmission allocations associated with a same TDRA index of transmission allocations.

Clause 23: The method of any combination of Clauses 17-22, wherein each list of one or more TDRA indexes comprises a TDRA index for each transmission allocation up to a specified maximum number of transmission occasions.

Clause 24: The method of any combination of Clauses 17-23, wherein each set of transmission allocations comprises a transmission allocation per bandwidth part (BWP) of each cell, of the multiple cells, up to a specified maximum number of BWPs.

Clause 25: The method of any combination of Clauses 1-24, wherein the communicating comprises at least one of: transmitting one or more physical uplink shared channel (PUSCH) transmissions in the multiple cells; or receiving one or more physical downlink shared channel (PDSCH) transmissions in the multiple cells.

Clause 26: A method of wireless communications by a network entity, comprising: transmitting signaling configuring a set of time domain resource allocations (TDRAs) for multiple cells, wherein at least one TDRA of the set of TDRAs is configured with multiple transmission allocations for one cell; transmitting signaling indicating at least one TDRA of the set of TDRAs; and communicating based on the indicated TDRA.

Clause 27: The method of Clause 26, wherein the transmitting of the signaling configuring the set of TDRAs comprises transmitting signaling configuring, for each cell of the multiple cells, a set of multiple physical downlink shared channel (multi-PDSCH) or multiple physical uplink shared channel (multi-PUSCH) TDRA tables.

Clause 28: The method of any combination of Clauses 26-27, wherein the transmitting of the signaling configuring the set of TDRAs comprises transmitting per bandwidth part (BWP), the signaling configuring, for each cell of the multiple cells, the set of multi-PDSCH or multi-PUSCH TDRA tables.

Clause 29: The method of any combination of Clauses 26-28, wherein the transmitting of the signaling configuring the set of TDRAs comprises transmitting signaling configuring: a list of one or more multi-transmission TDRA allocations; for each multi-transmission TDRA allocation, of the list of one or more multi-transmission TDRA allocations, a list of one or more TDRA indexes; for each TDRA index, of the list of one or more TDRA indexes, a set of one or more transmission allocation lists; and each transmission allocation list, of the set of one or more transmission allocation lists, a list of TDRAs.

Clause 30: The method of Clause 29, wherein the transmitting of the signaling configuring the set of TDRAs comprises transmitting a radio resource configuration (RRC) physical downlink shared channel (PDSCH) configuration information element (IE) or a physical uplink shared channel (PUSCH) configuration IE indicating the list of the one or more multi-transmission TDRA allocations.

Clause 31: The method of any combination of Clauses 29-30, wherein each list of one or more multi-transmission TDRA allocations comprises up to a specified maximum number of multi-transmission TDRA allocations.

Clause 32: The method of Clause 31, wherein the specified maximum number of allocations is 256.

Clause 33: The method of any combination of Clauses 29-32, wherein each list of one or more TDRA indexes comprises a TDRA index for each bandwidth part (BWP) of each cell of the multiple cells up to a specified maximum number of BWPs.

Clause 34: The method of any combination of Clauses 29-33, wherein each list of TDRAs comprises up to a specified maximum number of TDRAs associated with a same TDRA index.

Clause 35: The method of any combination of Clauses 26-34, wherein, for each cell of the multiple cells, a list of TDRA indexes comprises a TDRA index for each bandwidth part (BWP), having different subcarrier spacing (SCS), of the cell up to a specified maximum number of different SCSs or BWPs of the cell.

Clause 36: The method of Clause 35, further comprising transmitting signaling configuring the specified maximum number of different SCSs or BWPs of the cell

Clause 37: The method of any combination of Clauses 35-36, wherein the transmitting of the signaling indicating at least one TDRA of the set of TDRAs comprises transmitting a downlink control information (DCI) indicating an allocation of the list of allocations.

Clause 38: The method of Clause 37, wherein the DCI comprises a DCI format 0_3 or a DCI format 1_3.

Clause 39: The method of any combination of Clauses 29-38, wherein each list of TDRA indexes comprises a TDRA index for up to a specified maximum number of transmission allocations associated with a same TDRA index of transmission allocations.

Clause 40: The method of any combination of Clauses 29-39, wherein each list of TDRAs comprises up to a specified maximum number of transmission allocations per bandwidth part (BWP) of a cell.

Clause 41: The method of any combination of Clauses 26-40, wherein the transmitting of the signaling configuring the set of TDRAs comprises transmitting signaling configuring, for one or more multiple physical downlink shared channel (multi-PDSCH) transmission allocations or multiple physical uplink shared channel (multi-PUSCH) transmission allocations, a set of multiple cell TDRA tables.

Clause 42: The method of Clause 26 or 27, wherein the transmitting of the signaling configuring the set of TDRAs comprises transmitting signaling configuring: a list of one or more downlink control information (DCI) field indexes; for each DCI field index, of the one or more DCI field indexes, a list of TDRA indexes; and for each TDRA index, of the list of TDRA indexes, a set of transmission allocations.

Clause 43: The method of Clause 42, wherein the transmitting of the signaling configuring the set of TDRAs comprises transmitting a radio resource configuration (RRC) serving cell configuration information element (IE) indicating the list of TDRA indexes.

Clause 44: The method of any combination of Clauses 42-43, wherein the list of one or more DCI field indexes comprises up to a specified maximum number of DCI field indexes.

Clause 45: The method of Clause 44, wherein the specified maximum number of DCI field indexes is 256.

Clause 46: The method of any combination of Clauses 42-45, wherein each list of TDRA indexes comprises a TDRA index for each bandwidth part (BWP) of each cell of the multiple cells up to a specified maximum number of BWPs.

Clause 47: The method of any combination of Clauses 42-46, wherein each set of transmission allocations comprises up to a specified maximum number of transmission allocations associated with a same TDRA index of transmission allocations.

Clause 48: The method of any combination of Clauses 42-47, wherein each list of one or more TDRA indexes comprises a TDRA index for each transmission allocation up to a specified maximum number of transmission occasions.

Clause 49: The method of any combination of Clauses 42-48, wherein each set of transmission allocations comprises a transmission allocation per bandwidth part (BWP) of each cell, of the multiple cells, up to a specified maximum number of BWPs.

Clause 50: The method of any one of Clauses 26-49, wherein the communicating comprises at least one of: receiving one or more physical uplink shared channel (PUSCH) transmissions in the multiple cells; or transmitting one or more physical downlink shared channel (PDSCH) transmissions in the multiple cells.

Clause 51: An apparatus, comprising: at least one memory comprising executable instructions; and at least one processor configured to execute the executable instructions and cause the apparatus to perform a method in accordance with any combination of Clauses 1-50.

Clause 52: An apparatus, comprising means for performing a method in accordance with any combination of Clauses 1-50.

Clause 53: A non-transitory computer-readable medium comprising executable instructions that, when executed by at least one processor of an apparatus, cause the apparatus to perform a method in accordance with any combination of Clauses 1-50.

Clause 54: A computer program product embodied on a computer-readable storage medium comprising code for performing a method in accordance with any combination of Clauses 1-50.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration. Further, a processor may be an application processor, host processor, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs), processing blocks, or other discrete gate or transistor logic or circuitry (each of which may be generally referred to herein individually as “a processor” or “processor circuitry).

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. A group of processors collectively configurable or configured to perform a set of operations may include a first processor configurable or configured to perform a first operation of the set and a second processor configurable or configured to perform a second, different operation of the set. In some other examples, each of a group of processors may be configurable or configured to perform a same set of operations. Similarly, “a memory,” “at least one memory” or “one or more memories” generally refers to a single memory configured to store data and/or instructions, multiple memories configured to collectively store data and/or instructions.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a UE may also (or instead) be performed by a network entity (e.g., a BS or unit of a disaggregated BS). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the term “determine” or “determining” encompasses one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a″ (which may be a variation or example of at least one of a or a′ or a″) may be determined (or any of the other actions encompassed by usage of the word “determining” as described above) in accordance with b′″ (which may be a variation or example of at least one of b or b′ or b″). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications by a user equipment (UE), the apparatus comprising:
one or more memories storing computer executable code; and
one or more processors configured to execute the computer-executable code to cause the UE to:
receive signaling configuring a set of time domain resource allocations (TDRAs) for multiple cells, wherein at least one TDRA of the set of TDRAs is configured with multiple transmission allocations for one cell;
receive signaling indicating at least one TDRA of the set of TDRAs; and
communicate based on the indicated TDRA.

2. The apparatus of claim 1, wherein to receive the signaling configuring the set of TDRAs, the one or more processors are configured to cause the UE to receive signaling configuring, for each cell of the multiple cells, a set of multiple physical downlink shared channel (multi-PDSCH) or multiple physical uplink shared channel (multi-PUSCH) TDRA tables.

3. The apparatus of claim 1, wherein to receive the signaling configuring the set of TDRAs, the one or more processors are configured to cause the UE to receive per bandwidth part (BWP), the signaling configuring, for each cell of the multiple cells, the set of multi-PDSCH or multi-PUSCH TDRA tables.

4. The apparatus of claim 1, wherein to receive the signaling configuring the set of TDRAs, the one or more processors are configured to cause the UE to receive signaling configuring:
a list of one or more multi-transmission TDRA allocations;
for each multi-transmission TDRA allocation, of the list of one or more multi-transmission TDRA allocations, a list of one or more TDRA indexes;
for each TDRA index, of the list of one or more TDRA indexes, a set of one or more transmission allocation lists; and
each transmission allocation list, of the set of one or more transmission allocation lists, a list of TDRAs.

5. The apparatus of claim 4, wherein to receive the signaling configuring the set of TDRAs, the one or more processors are configured to cause the UE to receive a radio resource configuration (RRC) physical downlink shared channel (PDSCH) configuration information element (IE) or a RRC physical uplink shared channel (PUSCH) configuration IE indicating the list of the one or more multi-transmission TDRA allocations.

6. The apparatus of claim 4, wherein each list of one or more multi-transmission TDRA allocations comprises up to a specified maximum number of multi-transmission TDRA allocations.

7. The apparatus of claim 6, wherein the specified maximum number of allocations is 256.

8. The apparatus of claim 4, wherein each list of one or more TDRA indexes comprises a TDRA index for each bandwidth part (BWP) of each cell of the multiple cells up to a specified maximum number of BWPs.

9. The apparatus of claim 4, wherein each list of TDRAs comprises up to a specified maximum number of TDRAs associated with a same TDRA index.

10. The apparatus of claim 4, wherein to receive the signaling indicating the at least one TDRA of the set of TDRAs, the one or more processors are configured to cause the UE to receive a downlink control information (DCI) indicating an allocation of the list of allocations.

11. The apparatus of claim 10, wherein the DCI comprises a DCI format 0_3 or a DCI format 1_3.

12. The apparatus of claim 4, wherein each list of TDRA indexes comprises a TDRA index for up to a specified maximum number of transmission allocations associated with a same TDRA index of transmission allocations.

13. The apparatus of claim 4, wherein each list of TDRAs comprises up to a specified maximum number of transmission allocations per bandwidth part (BWP) of a cell.

14. The apparatus of claim 1, wherein, for each cell of the multiple cells, a list of TDRA indexes comprises a TDRA index for each bandwidth part (BWP), having different subcarrier spacing (SCS), of the cell up to a specified maximum number of different SCSs or BWPs of the cell.

15. The apparatus of claim 14, wherein the one or more processors are further configured to cause the UE to receive signaling configuring the specified maximum number of different SCS or BWPs of the cell.

16. The apparatus of claim 1, wherein to communicate based on the indicated TDRA, the one or more processors are configured to cause the UE to at least one of:
transmit one or more physical uplink shared channel (PUSCH) transmissions in the multiple cells; or
receive one or more physical downlink shared channel (PDSCH) transmissions in the multiple cells.

17. An apparatus for wireless communications by a network entity, the apparatus comprising:
one or more memories storing computer executable code; and
one or more processors configured to execute the computer-executable code to cause the network entity to:
transmit signaling configuring a set of time domain resource allocations (TDRAs) for multiple cells, wherein at least one TDRA of the set of TDRAs is configured with multiple transmission allocations for one cell;
transmit signaling indicating at least one TDRA of the set of TDRAs; and
communicate based on the indicated TDRA.

18. The apparatus of claim 17, wherein to cause the network entity to transmit the signaling configuring the set of TDRAs, the one or more processors are configured to cause the network entity to transmit signaling configuring, for each cell of the multiple cells, a set of multiple physical downlink shared channel (multi-PDSCH) or multiple physical uplink shared channel (multi-PUSCH) TDRA tables.

19. The apparatus of claim 17, wherein to cause the network entity to transmit the signaling configuring the set of TDRAs, the one or more processors are configured to cause the network entity to transmit per bandwidth part (BWP), the signaling configuring, for each cell of the multiple cells, the set of multi-PDSCH or multi-PUSCH TDRA tables.

20. A method of wireless communications by a user equipment (UE), the method comprising:
receiving signaling configuring a set of time domain resource allocations (TDRAs) for multiple cells, wherein at least one TDRA of the set of TDRAs is configured with multiple transmission allocations for one cell;
receiving signaling indicating at least one TDRA of the set of TDRAs; and
communicating based on the indicated TDRA.
